(19) United States
(12) Patent Application Publication
(10) Pub. No.: US 2011/0025689 A1
(43) Pub. Date: Feb. 3, 2011

(54) Auto-Generating A Visual Representation

(75) Inventors: Kathryn Stone Perez, Shoreline, WA (US); Alex Kipman, Redmond, WA (US); Nicholas D. Burton, Hermington (GB); Andrew Wilson, Ashby de la Zouch (GB)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 12/511,850

(22) Filed: Jul. 29, 2009

(51) Int. Cl. G06T 17/00

(52) U.S. Cl. 345/420

(57) ABSTRACT

Techniques for auto-generating the target's visual representation may reduce or eliminate the manual input required for the generation of the target's visual representation. For example, a system having a capture device may detect various features of a user in the physical space and make feature selections from a library of visual representation feature options based on the detected features. The system can automatically apply the selections to the visual representation of the user based on the detected features. Alternately, the system may make selections that narrow the number of options for features from which the user chooses. The system may apply the selections to the user in real time as well as make updates to the features selected and applied to the target's visual representation in real time.

### BACKGROUND

Applications often display a visual representation that corresponds to a user that the user controls through certain actions, such as selecting buttons on a remote or moving a controller in a certain manner. The visual representation may be in the form of an avatar, a fanciful character, a cartoon image or animal, a cursor, a hand, or the like. The visual representation is a computer representation that typically takes the form of a two-dimensional (2D) or three-dimensional (3D) model in various applications, such as computer games, video games, chats, forums, communities, instant messaging services, and the like. Many computing applications such as computer games, multimedia applications, office applications, or the like provide a selection of predefined animated characters that may be selected for use in the application as the user's avatar.

Most systems that allow for the creation of an avatar also allow for customization of that character's appearance by providing a database of selectable features that can be applied to the avatar. For example, the user can access a repository of clothing and accessories available in the application and make modifications to the avatar's appearance. Often, a user will select features that are most similar to the user's own features. For example, a user may select an avatar having a similar body structure as the user, and then the user may select similar eyes, nose, mouth, hair, etc, from a catalog of features. However, the number of features and the number of options for each of those features may result in an overwhelming number of options to choose from, and the manual generation of the user's visual representation may become burdensome. The system may limit the number of selectable features to reduce the effort required by the user, but this undesirably limits the features available for the user to generate a unique avatar.

### SUMMARY

It may be desirable that an application or system make feature selections for a user's visual representation on behalf of the user. Using the features selected, the system can auto-generate the user's visual representation. For example, the system may detect various features of the user and make feature selections based on the detected features. The system can automatically apply the selections to the visual representation of the user based on the detected features. Alternately, the system may make selections that narrow down the number of options for features from which the user chooses. The user may not be required to make as many decisions or have to select from as many options if the system can make decisions on behalf of the user. Thus, the disclosed techniques may remove a large amount of the effort of a user and can make selections, on behalf of the user, and apply them to the user's visual representation.

In an example embodiment, the system may perform a body scan and use facial recognition techniques and/or body recognition techniques to identify features of the user. The system may make selections for the user's visual representation that most closely resemble the identified features of the user. In another example embodiment, the system may modify the selection before applying the selection to the visual representation. The user may direct the system to make modifications before applying a selection to the user's visual representation. For example, if the user is overweight, the user may direct the system to select thinner body size for the user's visual representation.

The system may apply the selections to the user in real time. It may also be desirable that the system capture data from the physical space, identify the user's characteristics, and make updates to the features of the user's visual representation in real time.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

The systems, methods, and computer readable media for making feature selections and auto-generating a visual representation in accordance with this specification are further described with reference to the accompanying drawings in which:

FIG. 1 illustrates an example embodiment of a target recognition, analysis, and tracking system with a user playing a game.

FIG. 2 illustrates an example embodiment of a capture device that may be used in a target recognition, analysis, and tracking system and incorporate chaining and animation blending techniques.

FIG. 3 illustrates an example embodiment of a computing environment in which the animation techniques described herein may be embodied.

FIG. 4 illustrates another example embodiment of a computing environment in which the animation techniques described herein may be embodied.

FIG. 5 illustrates a skeletal mapping of a user that has been generated from a depth image.

FIGS. 6A-6B each depict an example target recognition, analysis, and tracking system and example embodiments of an auto-generated visual representation.

FIG. 7 depicts an example target recognition, analysis, and tracking system that provides a subset of feature options for application to a target's visual representation.

FIG. 8 depicts an example flow diagram for a method of auto-generating a visual representation or a subset of feature options for application to a visual representation.

FIG. 9 depicts an example target recognition, analysis, and tracking system that uses target digitization techniques to identify targets in the physical space.

### DETAILED DESCRIPTION OF ILLUSTRATIVE EMBODIMENTS

Disclosed herein are techniques for providing a visual representation of a target, such as a user or non-human object in the physical space. The visual representation of a user, for example, may be in the form of an avatar, a cursor on the screen, a hand, or the any other virtual object that corresponds to the user in the physical space. Aspects of a skeletal or mesh model of a person may be generated based on the image data captured by the capture device and can be evaluated to detect the user's characteristics. The capture device may detect features of a user and auto-generate a visual representation of the user by selecting features from a catalog of features that resemble those detected features, such as facial expressions, hair color and type, skin color and type, clothing, body type, height, weight, etc. For example, using facial recognition and gesture/body posture recognition techniques, the system can automatically select features from a catalog or database of feature options that correspond to the recognized features. In real time, the system can apply the selected features, and any updates to those features, to the user's visual representation. Similarly, the system may detect features of non-human targets in the physical space and select features from a catalog of feature options for virtual objects. The system may display a virtual object that corresponds to the detected features.

The computing environment may determine which controls to perform in an application executing on the computer environment based on, for example, gestures of the user that have been recognized and mapped to the visual representation auto-generated by the system. Thus, a virtual user may be displayed and the user can control the virtual user's motion by making gestures in the physical space. Captured motion may be any motion in the physical space that is captured by the capture device, such as a camera. The captured motion could include the motion of a target in the physical space, such as a user or an object. The captured motion may include a gesture that translates to a control in an operating system or application. The motion may be dynamic, such as a running motion, or the motion may be static, such as a user that is posed with little movement.

The system, methods, techniques, and components of facial and body recognition for making selections for a visual representation based on detectable user characteristics may be embodied in a multi-media console, such as a gaming console, or in any other computing device in which it is desired to display a visual representation of a target, including, by way of example and without any intended limitation, satellite receivers, set top boxes, arcade games, personal computers (PCs), portable telephones, personal digital assistants (PDAs), and other hand-held devices.

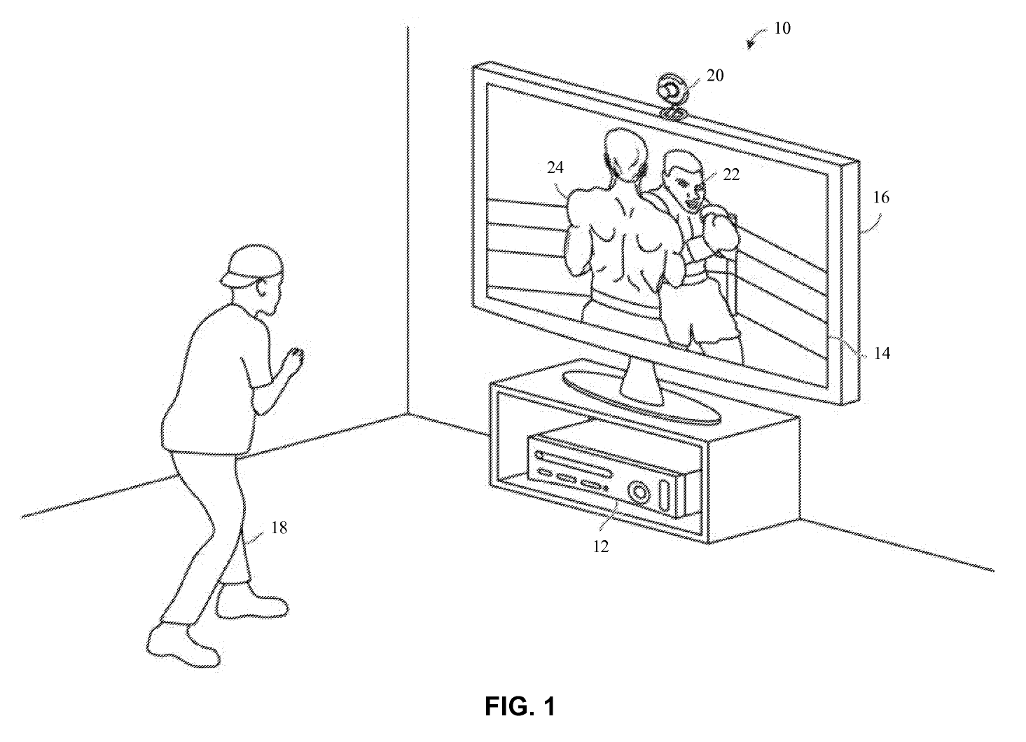

FIG. 1 illustrates an example embodiment of a configuration of a target recognition, analysis, and tracking system 10 that may employ techniques for applying characteristics of the user to an avatar. In the example embodiment, a user 18 is playing a boxing game. In an example embodiment, the system 10 may recognize, analyze, and/or track a human target such as the user 18. The system 10 may gather information related to the user's motions, facial expressions, body language, emotions, etc, in the physical space. For example, the system may identify and scan the human target 18. The system 10 may use body posture recognition techniques to identify the body type of the human target 18. The system 10 may identify the body parts of the user 18 and how they move. The system 10 may compare the detected user features to a catalog of selectable visual representation features.

As shown in FIG. 1, the target recognition, analysis, and tracking system 10 may include a computing environment 12. The computing environment 12 may be a computer, a gaming system or console, or the like. According to an example embodiment, the computing environment 12 may include hardware components and/or software components such that the computing environment 12 may be used to execute applications such as gaming applications, non-gaming applications, or the like.

As shown in FIG. 1, the target recognition, analysis, and tracking system 10 may further include a capture device 20. The capture device 20 may be, for example, a camera that may be used to visually monitor one or more users, such as the user 18, such that gestures performed by the one or more users may be captured, analyzed, and tracked to perform one or more controls or actions within an application, as will be described in more detail below.

According to one embodiment, the target recognition, analysis, and tracking system 10 may be connected to an audiovisual device 16 such as a television, a monitor, a high-definition television (HDTV), or the like that may provide game or application visuals and/or audio to a user such as the user 18. For example, the computing environment 12 may include a video adapter such as a graphics card and/or an audio adapter such as a sound card that may provide audiovisual signals associated with the game application, non-game application, or the like. The audiovisual device 16 may receive the audiovisual signals from the computing environment 12 and may then output the game or application visuals and/or audio associated with the audiovisual signals to the user 18. According to one embodiment, the audiovisual device 16 may be connected to the computing environment 12 via, for example, an S-Video cable, a coaxial cable, an HDMI cable, a DVI cable, a VGA cable, or the like.

As shown in FIG. 1, the target recognition, analysis, and tracking system 10 may be used to recognize, analyze, and/or track a human target such as the user 18. For example, the user 18 may be tracked using the capture device 20 such that the movements of user 18 may be interpreted as controls that may be used to affect the application being executed by computer environment 12. Thus, according to one embodiment, the user 18 may move his or her body to control the application. The system 10 may track the user's body and the motions made by the user's body, including gestures that control aspects of the system, such as the application, operating system, or the like.

The system 10 may translate an input to a capture device 20 into an animation, the input being representative of a user's motion, such that the animation is driven by that input. Thus, the user's motions may map to an avatar 40 such that the user's motions in the physical space are performed by the avatar 40. The user's motions may be gestures that are applicable to a control in an application. As shown in FIG. 1, in an example embodiment, the application executing on the computing environment 12 may be a boxing game that the user 18 may be playing.

The computing environment 12 may use the audiovisual device 16 to provide the visual representation of a player avatar 40 that the user 18 may control with his or her movements. The system may apply the motions and/or gestures to the user's visual representation, which may be an auto-generated visual representation, auto-generated by the system based on the user's detected features. For example, the user 18 may throw a punch in physical space to cause the player avatar 40 to throw a punch in game space. The player avatar 40 may have the characteristics of the user identified by the capture device 20, or the system 10 may use the features of a well-known boxer or portray the physique of a professional boxer for the visual representation that maps to the user's motions. The system 10 may track the user and modify characteristics of the user's avatar based on detectable features of the user in the physical space. The computing environment 12 may also use the audiovisual device 16 to provide a visual representation of a boxing opponent 38 to the user 18. According to an example embodiment, the computer environment 12 and the capture device 20 of the target recognition, analysis, and tracking system 10 may be used to recognize and analyze the punch of the user 18 in physical space such that the punch may be interpreted as a game control of the player avatar 40 in game space. Multiple users can interact with each other from remote locations. For example, the visual representation of the boxing opponent 38 may be representative of another user, such as a second user in the physical space with user 18 or a networked user in a second physical space.

Other movements by the user 18 may also be interpreted as other controls or actions, such as controls to bob, weave, shuffle, block, jab, or throw a variety of different power punches. Furthermore, some movements may be interpreted as controls that may correspond to actions other than controlling the player avatar 40. For example, the player may use movements to end, pause, or save a game, select a level, view high scores, communicate with a friend, etc. Additionally, a full range of motion of the user 18 may be available, used, and analyzed in any suitable manner to interact with an application.

In example embodiments, the human target such as the user 18 may have an object. In such embodiments, the user of an electronic game may be holding the object such that the motions of the player and the object may be used to adjust and/or control parameters of the game. For example, the motion of a player holding a racket may be tracked and utilized for controlling an on-screen racket in an electronic sports game. In another example embodiment, the motion of a player holding an object may be tracked and utilized for controlling an on-screen weapon in an electronic combat game.

A user's gestures or motion may be interpreted as controls that may correspond to actions other than controlling the player avatar 40. For example, the player may use movements to end, pause, or save a game, select a level, view high scores, communicate with a friend, etc. The player may use movements to apply modifications to the avatar. For example, the user may shake his or her arm in the physical space and this may be a gesture identified by the system 10 as a request to make the avatar's arm longer. Virtually any controllable aspect of an operating system and/or application may be controlled by movements of the target such as the user 18. According to other example embodiments, the target recognition, analysis, and tracking system 10 may interpret target movements for controlling aspects of an operating system and/or application that are outside the realm of games.

The user's gesture may be controls applicable to an operating system, non-gaming aspects of a game, or a non-gaming application. The user's gestures may be interpreted as object manipulation, such as controlling a user interface. For example, consider a user interface having blades or a tabbed interface lined up vertically left to right, where the selection of each blade or tab opens up the options for various controls within the application or the system. The system may identify the user's hand gesture for movement of a tab, where the user's hand in the physical space is virtually aligned with a tab in the application space. The gesture, including a pause, a grabbing motion, and then a sweep of the hand to the left, may be interpreted as the selection of a tab, and then moving it out of the way to open the next tab.

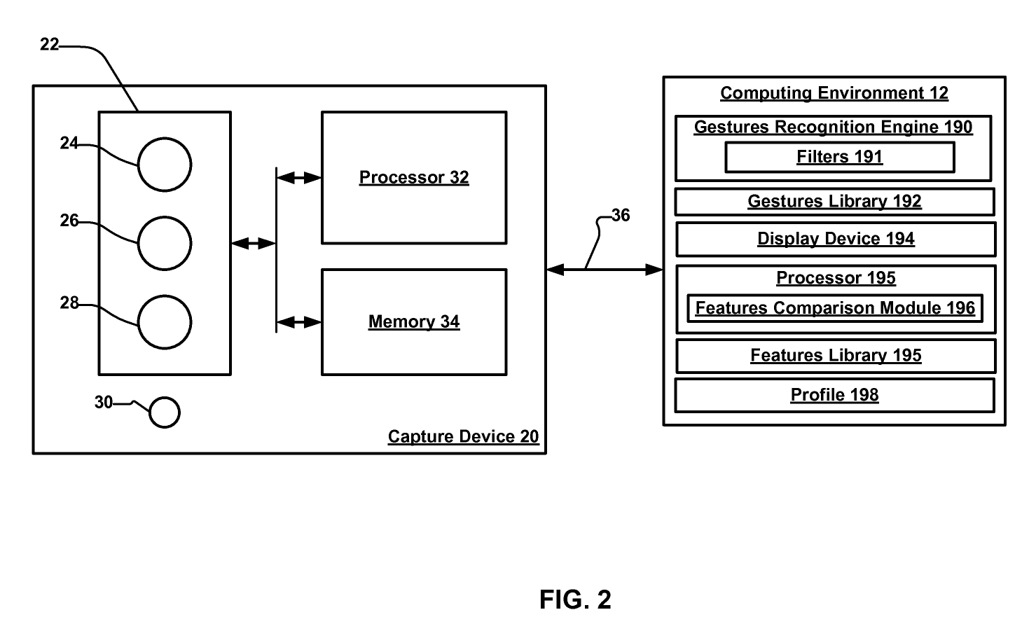

FIG. 2 illustrates an example embodiment of a capture device 20 that may be used for target recognition, analysis, and tracking, where the target can be a user or an object. According to an example embodiment, the capture device 20 may be configured to capture video with depth information including a depth image that may include depth values via any suitable technique including, for example, time-of-flight, structured light, stereo image, or the like. According to one embodiment, the capture device 20 may organize the calculated depth information into “Z layers,” or layers that may be perpendicular to a Z axis extending from the depth camera along its line of sight.

As shown in FIG. 2, the capture device 20 may include an image camera component 22. According to an example embodiment, the image camera component 22 may be a depth camera that may capture the depth image of a scene. The depth image may include a two-dimensional (2-D) pixel area of the captured scene where each pixel in the 2-D pixel area may represent a depth value such as a length or distance in, for example, centimeters, millimeters, or the like of an object in the captured scene from the camera.

As shown in FIG. 2, according to an example embodiment, the image camera component 22 may include an IR light component 24, a three-dimensional (3-D) camera 26, and an RGB camera 28 that may be used to capture the depth image of a scene. For example, in time-of-flight analysis, the IR light component 24 of the capture device 20 may emit an infrared light onto the scene and may then use sensors (not shown) to detect the backscattered light from the surface of one or more targets and objects in the scene using, for example, the 3-D camera 26 and/or the RGB camera 28. In some embodiments, pulsed infrared light may be used such that the time between an outgoing light pulse and a corresponding incoming light pulse may be measured and used to determine a physical distance from the capture device 20 to a particular location on the targets or objects in the scene. Additionally, in other example embodiments, the phase of the outgoing light wave may be compared to the phase of the incoming light wave to determine a phase shift. The phase shift may then be used to determine a physical distance from the capture device 20 to a particular location on the targets or objects.

According to another example embodiment, time-of-flight analysis may be used to indirectly determine a physical distance from the capture device 20 to a particular location on the targets or objects by analyzing the intensity of the reflected beam of light over time via various techniques including, for example, shuttered light pulse imaging.

In another example embodiment, the capture device 20 may use a structured light to capture depth information. In such an analysis, patterned light (i.e., light displayed as a known pattern such as grid pattern or a stripe pattern) may be projected onto the scene via, for example, the IR light component 24. Upon striking the surface of one or more targets or objects in the scene, the pattern may become deformed in response. Such a deformation of the pattern may be captured by, for example, the 3-D camera 26 and/or the RGB camera 28 and may then be analyzed to determine a physical distance from the capture device 20 to a particular location on the targets or objects.

According to another embodiment, the capture device 20 may include two or more physically separated cameras that may view a scene from different angles, to obtain visual stereo data that may be resolved to generate depth information.

In another example embodiment, the capture device 20 may use point cloud data and target digitization techniques to detect features of the user. These techniques are provided in more detail below with respect to FIG. 2B.

The capture device 20 may further include a microphone 30, or an array of microphones. The microphone 30 may include a transducer or sensor that may receive and convert sound into an electrical signal. According to one embodiment, the microphone 30 may be used to reduce feedback between the capture device 20 and the computing environment 12 in the target recognition, analysis, and tracking system 10. Additionally, the microphone 30 may be used to receive audio signals that may also be provided by the user to control applications such as game applications, non-game applications, or the like that may be executed by the computing environment 12.

In an example embodiment, the capture device 20 may further include a processor 32 that may be in operative communication with the image camera component 22. The processor 32 may include a standardized processor, a specialized processor, a microprocessor, or the like that may execute instructions that may include instructions for receiving the depth image, determining whether a suitable target may be included in the depth image, converting the suitable target into a skeletal representation or model of the target, or any other suitable instruction.

For example, the computer-readable medium may comprise computer executable instructions for receiving data of a scene, wherein the data includes data representative of the target in a physical space. The instructions comprise instructions for detecting at least one target feature from the data, and comparing the at least one detected target feature to visual representation feature options from the features library 197. The visual representation feature options may comprise selectable options configured for application to the visual representation. Further instructions provide for selecting a visual representation feature from the visual representation feature options, applying the visual representation feature to the visual representation of the target, and rendering the visual representation. The visual representation may be auto-generated from the comparison of the at least one detected feature to the visual representation feature options such that the selection of the visual representation feature is performed without manual selection by a user.

The selection of the visual representation feature may comprise selecting the visual representation feature that is similar to the detected target feature. The visual representation feature may be at least one of a facial feature, a body part, a color, a size, a height, a width, a shape, an accessory, or a clothing item. The instructions may provide for generating a subset of visual representation feature options, from the visual representation feature options, for the visual representation feature, and providing the generated subset of feature options for user selection of the visual representation feature to apply to the visual representation. The generated subset of visual representation feature options may comprise multiple visual representation feature options that are similar to the detected target feature. The instructions may provide for receiving a user selection of a visual representation feature from the generated subset of feature options, wherein selecting the visual representation feature from the visual representation feature options comprises selecting the visual representation feature that corresponds to the user selection. The visual representation, having the visual representation feature, may be rendered in real time. Furthermore, the instructions may provide for monitoring the target and detecting a change in the detected target feature, and updating the visual representation of the target by updating the visual representation feature applied to the visual representation, in real time, based on the change in the detected target feature.

The capture device 20 may further include a memory component 34 that may store the instructions that may be executed by the processor 32, images or frames of images captured by the 3-d camera 26 or RGB camera 28, or any other suitable information, images, or the like. According to an example embodiment, the memory component 34 may include random access memory (RAM), read only memory (ROM), cache, Flash memory, a hard disk, or any other suitable storage component. As shown in FIG. 2, in one embodiment, the memory component 34 may be a separate component in communication with the image capture component 22 and the processor 32. According to another embodiment, the memory component 34 may be integrated into the processor 32 and/or the image capture component 22.

As shown in FIG. 2, the capture device 20 may be in communication with the computing environment 12 via a communication link 36. The communication link 36 may be a wired connection including, for example, a USB connection, a Firewire connection, an Ethernet cable connection, or the like and/or a wireless connection such as a wireless 802.11b, g, a, or n connection. According to one embodiment, the computing environment 12 may provide a clock to the capture device 20 that may be used to determine when to capture, for example, a scene via the communication link 36.

Additionally, the capture device 20 may provide the depth information and images captured by, for example, the 3-D camera 26 and/or the RGB camera 28, and a skeletal model that may be generated by the capture device 20 to the computing environment 12 via the communication link 36. The computing environment 12 may then use the skeletal model, depth information, and captured images to, for example, control an application such as a game or word processor. For example, as shown, in FIG. 2, the computing environment 12 may include a gestures library 192.

As shown, in FIG. 2, the computing environment 12 may include a gestures library 192 and a gestures recognition engine 190. The gestures recognition engine 190 may include a collection of gesture filters 191. A filter may comprise code and associated data that can recognize gestures or otherwise process depth, RGB, or skeletal data. Each filter 191 may comprise information defining a gesture along with parameters, or metadata, for that gesture. For instance, a throw, which comprises motion of one of the hands from behind the rear of the body to past the front of the body, may be implemented as a gesture filter 191 comprising information representing the movement of one of the hands of the user from behind the rear of the body to past the front of the body, as that movement would be captured by a depth camera. Parameters may then be set for that gesture. Where the gesture is a throw, a parameter may be a threshold velocity that the hand has to reach, a distance the hand must travel (either absolute, or relative to the size of the user as a whole), and a confidence rating by the recognizer engine that the gesture occurred. These parameters for the gesture may vary between applications, between contexts of a single application, or within one context of one application over time.

While it is contemplated that the gestures recognition engine 190 may include a collection of gesture filters, where a filter may comprise code or otherwise represent a component for processing depth, RGB, or skeletal data, the use of a filter is not intended to limit the analysis to a filter. The filter is a representation of an example component or section of code that analyzes data of a scene received by a system, and comparing that data to base information that represents a gesture. As a result of the analysis, the system may produce an output corresponding to whether the input data corresponds to the gesture. The base information representing the gesture may be adjusted to correspond to the recurring feature in the history of data representative of the user's capture motion. The base information, for example, may be part of a gesture filter as described above. But, any suitable manner for analyzing the input data and gesture data is contemplated.

In an example embodiment, a gesture may be recognized as a trigger for the entry into a modification mode, where a user can modify the visual representation auto-generated by the system. For example, a gesture filter 191 may comprise information for recognizing a modification trigger gesture. If the modification trigger gesture is recognized, the application may go into a modification mode. The modification trigger gesture may vary between applications, between systems, between users, or the like. For example, the same gesture in a tennis gaming application may not be the same modification trigger gesture in a bowling game application. Consider an example modification trigger gesture that comprises a user motioning the user's right hand, presented in front of the user's body, with the pointer finger pointing upward and moving in a circular motion. The parameters set for the modification trigger gesture may be used to identify that the user's hand is in front of the user's body, the user's pointer finger is pointed in an upward motion, and identifying that the pointer finger is moving in a circular motion.

Certain gestures may be identified as a request to enter into a modification mode, where if an application is currently executing, the modification mode interrupts the current state of the application and enters into a modification mode. The modification mode may cause the application to pause, where the application can be resumed at the pause point when the user leaves the modification mode. Alternately, the modification mode may not result in a pause to the application, and the application may continue to execute while the user makes modifications.

The data captured by the cameras 26, 28 and device 20 in the form of the skeletal model and movements associated with it may be compared to the gesture filters 191 in the gestures library 192 to identify when a user (as represented by the skeletal model) has performed one or more gestures. Thus, inputs to a filter such as filter 191 may comprise things such as joint data about a user's joint position, like angles formed by the bones that meet at the joint, RGB color data from the scene, and the rate of change of an aspect of the user. As mentioned, parameters may be set for the gesture. Outputs from a filter 191 may comprise things such as the confidence that a given gesture is being made, the speed at which a gesture motion is made, and a time at which the gesture occurs.

The computing environment 12 may include a processor 195 that can process the depth image to determine what targets are in a scene, such as a user 18 or an object in the room. This can be done, for instance, by grouping together of pixels of the depth image that share a similar distance value. The image may also be parsed to produce a skeletal representation of the user, where features, such as joints and tissues that run between joints are identified. There exist skeletal mapping techniques to capture a person with a depth camera and from that determine various spots on that user's skeleton, joints of the hand, wrists, elbows, knees, nose, ankles, shoulders, and where the pelvis meets the spine. Other techniques include transforming the image into a body model representation of the person and transforming the image into a mesh model representation of the person.

In an embodiment, the processing is performed on the capture device 20 itself, and the raw image data of depth and color (where the capture device 20 comprises a 3D camera 26) values are transmitted to the computing environment 12 via link 36. In another embodiment, the processing is performed by a processor 32 coupled to the camera 402 and then the parsed image data is sent to the computing environment 12. In still another embodiment, both the raw image data and the parsed image data are sent to the computing environment 12. The computing environment 12 may receive the parsed image data but it may still receive the raw data for executing the current process or application. For instance, if an image of the scene is transmitted across a computer network to another user, the computing environment 12 may transmit the raw data for processing by another computing environment.

The processor may have a features comparison module 196. The features comparison module 196 may compare the detected features of a target to the options in the features library 197. The features library 197 may provide visual representation feature options, such as color options, facial feature options, body type options, size options, etc, and the options may vary for human and non-human targets. The library may be a catalog, a database, memory, or the like, that stores the features for the visual representation. The library may an organized or unorganized collection of features options. The system or user may add features to the catalog. For example, an application may have a pre-packaged set of feature options or the system may have a default number of available features. Additional feature options may be added to or updated in the features library 197. For example, the user may purchase additional feature options in a virtual marketplace, a user may gift feature options to another user, or the system may generate feature options by taking a snapshot of the user's detected features.

The FCM 196 may make feature selections, such as from the catalog of feature options, that most closely resemble the detected features of the target. The system may auto-generate a virtual object that has the detected features. For example, consider the detection of a red, two-seater couch in the physical space. The system may identify the features from the features library 197 that, alone or in combination, resemble the detected target features of the couch. In an example embodiment, the selection from the features library 197 may be as simple as selecting a virtual target that has at least one feature of the physical target. For example, the features library 197 may have numerous feature options for furniture and may include a virtual image or depiction of a red, two-seater couch. Such features may be pre-packaged and provided with an application or with the system. In another example, the system may take a snapshot of the physical couch and create a cartoon or virtual image that takes the shape of the physical couch. Thus, the feature selected may be from a snapshot of the physical couch previously taken by the system and added to the features library 197.

The system may adjust the color, positioning, or scale of a selected feature based on the detected target features. For example, the system may select a feature or combine several features from the features library 197 that resemble the features of the detected target. The system may add features to a selected feature or virtual image to more fully resemble the detected target. In the example of the detected couch, the system may perform a feature look-up in the features library 197 and identify a virtual frame for a couch having at least one feature that resembles a feature of the physical couch. For example, the system may initially select a virtual couch that resembles the detected physical couch in shape. If a virtual two-seater couch is an available feature option, the system may select the virtual two-seater. Colors may be feature options selectable by the system. In this example, if a red couch is specifically not an option in the features library 197, the system may select a color from the features library 197 and apply it to the virtual frame selected. The system may select an existing color in the features library 197 that resembles the detected red color of the physical couch, or the system may take a snapshot of the color of the physical couch and add it to the features library as a feature option. The system may apply the selected red color feature to the virtual couch image.

In another example, the system may combine features from the features library to generate a visual object that resembles the detected target. For example, the system may generate a two-seater couch by selecting from couch feature options from the features library 197, such as arms, legs, seats, cushions, back, spine, etc and piece together a couch with the selected features.

In another example, the target is a user and the system detects the user's features, such as eye color, size, and shape, hair color, type, and length, etc. The system may compare the detected features to a catalog of feature options and apply selected features to the visual representation. As described above, the system may combine features and alter those features. For example, the features may be altered by applying a color, positioning, or scaling to the target. The features may be altered by the selection of additional features from the features library 197, such as a color, or by using image data from a snapshot of the target. For example, an application may provide a generic set of solid color pants, t-shirts, and shoe types in the features library 197. The system may select from the generic clothing features but alter the selected clothing features by applying colors to the clothing to reflect the colors of the target's clothing detected by the system.

In another example, the system may identify a subset of features in the features library 197 that resemble the user's features and provide the subset from which the user may choose. Thus, the number of options provided to the user for a particular feature may be intelligently filtered to make it easier for the user to customize the visual representation.

The features library may apply to applicable to an application or may be system-wide. For example, a game application may define the features that indicate the various temperaments applicable to the game. The feature options may include specific and general features. It is also noted that references to a lookup table or database are exemplary, and it is contemplated that the provision of feature options related to the techniques disclosed herein may be accessed, stored, packaged, provided, generated, or the like, in any manner suitable.

The computing environment 12 may use the gestures library 192 to interpret movements of the skeletal model and to control an application based on the movements. The computing environment 12 can model and display a representation of a user, such as in the form of an avatar or a pointer on a display, such as in a display device 193. Display device 193 may include a computer monitor, a television screen, or any suitable display device. For example, a camera-controlled computer system may capture user image data and display user feedback on a television screen that maps to the user's gestures. The user feedback may be displayed as an avatar on the screen such as shown in FIGS. 1A and 1B. The avatar's motion can be controlled directly by mapping the avatar's movement to those of the user's movements. The user's gestures may be interpreted control certain aspects of the application.

According to an example embodiment, the target may be a human target in any position such as standing or sitting, a human target with an object, two or more human targets, one or more appendages of one or more human targets or the like that may be scanned, tracked, modeled and/or evaluated to generate a virtual screen, compare the user to one or more stored profiles and/or to store profile information 198 about the target in a computing environment such as computing environment 12. The profile information 198 may be in the form of user profiles, personal profiles, application profiles, system profiles, or any other suitable method for storing data for later access. The profile information 198 may be accessible via an application or be available system-wide, for example. The profile information 198 may include lookup tables for loading specific user profile information. The virtual screen may interact with an application that may be executed by the computing environment 12 described above with respect to FIGS. 1A-1B.

The system may render a visual representation of a target, such as a user, by auto-generating the visual representation based on information stored in the user's profile. According to example embodiments, lookup tables may include user specific profile information. In one embodiment, the computing environment such as computing environment 12 may include stored profile data 198 about one or more users in lookup tables. The stored profile data 198 may include, among other things the targets scanned or estimated body size, skeletal models, body models, voice samples or passwords, the target's gender, the targets age, previous gestures, target limitations and standard usage by the target of the system, such as, for example a tendency to sit, left or right handedness, or a tendency to stand very near the capture device. This information may be used to determine if there is a match between a target in a capture scene and one or more user profiles 198, that, in one embodiment, may allow the system to adapt the virtual screen to the user, or to adapt other elements of the computing or gaming experience according to the profile 198.

Previously selected features for the target's visual representation may be stored in a profile. For example, a user-specific profile may store the features selected and applied to auto-generate the user's visual representation. A location-specific profile may store features selected and applied to auto-generate and display a virtual scene that resembles the physical space. For example, virtual objects that correspond to objects in the physical space, such as furniture in the room, may be generated by selecting from options in the features library 197. Colors may be detected and available colors may be selected from the features library 197. Upon recognition or initialization by the system, the location-specific profile may be loaded, displaying the furniture and colors that correspond to the location.

One or more personal profiles 198 may be stored in computer environment 12 and used in a number of user sessions, or one or more personal profiles may be created for a single session only. Users may have the option of establishing a profile where they may provide information to the system such as a voice or body scan, age, personal preferences, right or left handedness, an avatar, a name or the like. Personal profiles may also be provided for “guests” who do not provide any information to the system beyond stepping into the capture space. A temporary personal profile may be established for one or more guests. At the end of a guest session, the guest personal profile may be stored or deleted.

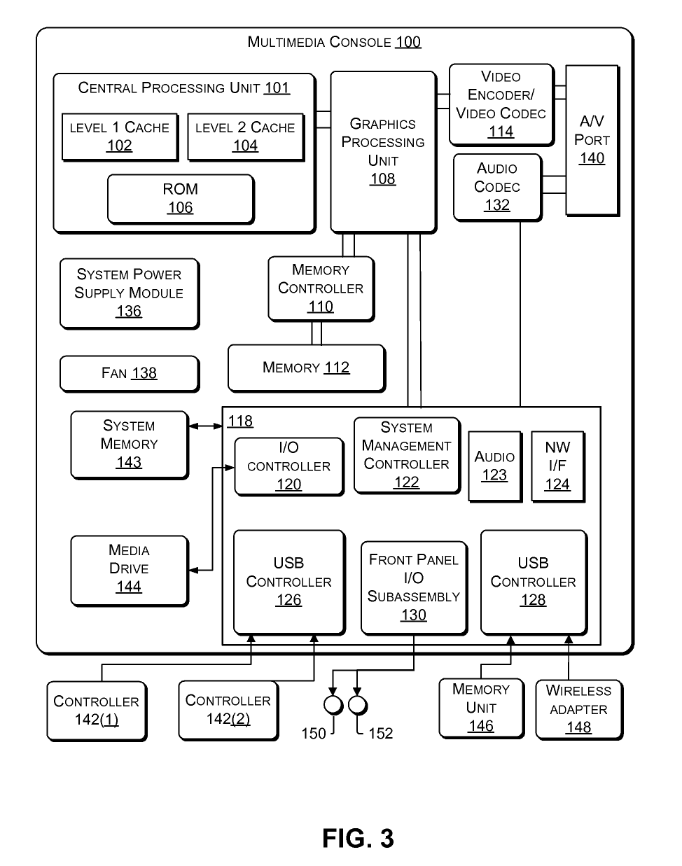

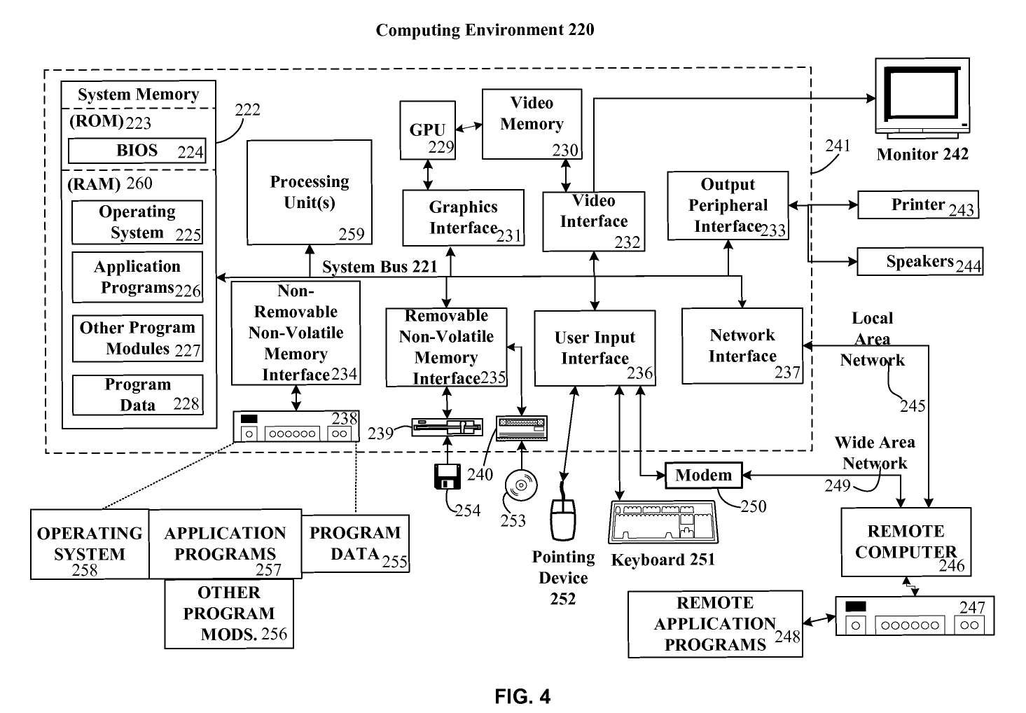

The gestures library 192, gestures recognition engine 190, features library 197, features comparer 196 and profile 198 may be implemented in hardware, software or a combination of both. For example, the gestures library 192, and gestures recognition engine 190. may be implemented as software that executes on a processor, such as processor 195, of the computing environment 12 (or on processing unit 101 of FIG. 3 or processing unit 259 of FIG. 4).

It is emphasized that the block diagram depicted in FIGS. 3-4 described below are exemplary and not intended to imply a specific implementation. Thus, the processor 195 or 32 in FIG. 1, the processing unit 101 of FIG. 3, and the processing unit 259 of FIG. 4, can be implemented as a single processor or multiple processors. Multiple processors can be distributed or centrally located. For example, the gestures library 192 may be implemented as software that executes on the processor 32 of the capture device or it may be implemented as software that executes on the processor 195 in the computing environment 12. Any combination of processors that are suitable for performing the techniques disclosed herein are contemplated. Multiple processors can communicate wirelessly, via hard wire, or a combination thereof.

Furthermore, as used herein, a computing environment 12 may refer to a single computing device or to a computing system. The computing environment may include non-computing components. The computing environment may include a display device, such as display device 193 shown in FIG. 2. A display device may be an entity separate but coupled to the computing environment or the display device may be the computing device that processes and displays, for example. Thus, a computing system, computing device, computing environment, computer, processor, or other computing component may be used interchangeably.

The gestures library and filter parameters may be tuned for an application or a context of an application by a gesture tool. A context may be a cultural context, and it may be an environmental context. A cultural context refers to the culture of a user using a system. Different cultures may use similar gestures to impart markedly different meanings. For instance, an American user who wishes to tell another user to “look” or “use his eyes” may put his index finger on his head close to the distal side of his eye. However, to an Italian user, this gesture may be interpreted as a reference to the mafia.

Similarly, there may be different contexts among different environments of a single application. Take a first-user shooter game that involves operating a motor vehicle. While the user is on foot, making a fist with the fingers towards the ground and extending the fist in front and away from the body may represent a punching gesture. While the user is in the driving context, that same motion may represent a “gear shifting” gesture. With respect to modifications to the visual representation, different gestures may trigger different modifications depending on the environment. A different modification trigger gesture could be used for entry into an application-specific modification mode versus a system-wide modification mode. Each modification mode may be packaged with an independent set of gestures that correspond to the modification mode, entered into as a result of the modification trigger gesture. For example, in a bowling game, a swinging arm motion may be a gesture identified as swinging a bowling ball for release down a virtual bowling alley. However, in another application, the swinging arm motion may be a gesture identified as a request to lengthen the arm of the user's avatar displayed on the screen. There may also be one or more menu environments, where the user can save his game, select among his character's equipment or perform similar actions that do not comprise direct game-play. In that environment, this same gesture may have a third meaning, such as to select something or to advance to another screen.

Gestures may be grouped together into genre packages of complimentary gestures that are likely to be used by an application in that genre. Complimentary gestures—either complimentary as in those that are commonly used together, or complimentary as in a change in a parameter of one will change a parameter of another—may be grouped together into genre packages. These packages may be provided to an application, which may select at least one. The application may tune, or modify, the parameter of a gesture or gesture filter 191 to best fit the unique aspects of the application. When that parameter is tuned, a second, complimentary parameter (in the inter-dependent sense) of either the gesture or a second gesture is also tuned such that the parameters remain complimentary. Genre packages for video games may include genres such as first-user shooter, action, driving, and sports.

FIG. 3 illustrates an example embodiment of a computing environment that may be used to interpret one or more gestures in a target recognition, analysis, and tracking system. The computing environment such as the computing environment 12 described above with respect to FIGS. 1A-2 may be a multimedia console 100, such as a gaming console. As shown in FIG. 3, the multimedia console 100 has a central processing unit (CPU) 101 having a level 1 cache 102, a level 2 cache 104, and a flash ROM (Read Only Memory) 106. The level 1 cache 102 and a level 2 cache 104 temporarily store data and hence reduce the number of memory access cycles, thereby improving processing speed and throughput. The CPU 101 may be provided having more than one core, and thus, additional level 1 and level 2 caches 102 and 104. The flash ROM 106 may store executable code that is loaded during an initial phase of a boot process when the multimedia console 100 is powered ON.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a television or other display. A memory controller 110 is connected to the GPU 108 to facilitate processor access to various types of memory 112, such as, but not limited to, a RAM (Random Access Memory).

The multimedia console 100 includes an I/O controller 120, a system management controller 122, an audio processing unit 123, a network interface controller 124, a first USB host controller 126, a second USB controller 128 and a front panel I/O subassembly 130 that are preferably implemented on a module 118. The USB controllers 126 and 128 serve as hosts for peripheral controllers 142(1)-142(2), a wireless adapter 148, and an external memory device 146 (e.g., flash memory, external CD/DVD ROM drive, removable media, etc.). The network interface 124 and/or wireless adapter 148 provide access to a network (e.g., the Internet, home network, etc.) and may be any of a wide variety of various wired or wireless adapter components including an Ethernet card, a modem, a Bluetooth module, a cable modem, and the like.

System memory 143 is provided to store application data that is loaded during the boot process. A media drive 144 is provided and may comprise a DVD/CD drive, hard drive, or other removable media drive, etc. The media drive 144 may be internal or external to the multimedia console 100. Application data may be accessed via the media drive 144 for execution, playback, etc. by the multimedia console 100. The media drive 144 is connected to the I/O controller 120 via a bus, such as a Serial ATA bus or other high speed connection (e.g., IEEE 1394).

The system management controller 122 provides a variety of service functions related to assuring availability of the multimedia console 100. The audio processing unit 123 and an audio codec 132 form a corresponding audio processing pipeline with high fidelity and stereo processing. Audio data is carried between the audio processing unit 123 and the audio codec 132 via a communication link. The audio processing pipeline outputs data to the A/V port 140 for reproduction by an external audio player or device having audio capabilities.

The front panel I/O subassembly 130 supports the functionality of the power button 150 and the eject button lnposelstart152lnposelend, as well as any LEDs (light emitting diodes) or other indicators exposed on the outer surface of the multimedia console 100. A system power supply module 136 provides power to the components of the multimedia console 100. A fan 138 cools the circuitry within the multimedia console 100.

The CPU 101, GPU 108, memory controller 110, and various other components within the multimedia console 100 are interconnected via one or more buses, including serial and parallel buses, a memory bus, a peripheral bus, and a processor or local bus using any of a variety of bus architectures. By way of example, such architectures can include a Peripheral Component Interconnects (PCI) bus, PCI-Express bus, etc.

When the multimedia console 100 is powered ON, application data may be loaded from the system memory 143 into memory 112 and/or caches 102, 104 and executed on the CPU 101. The application may present a graphical user interface that provides a consistent user experience when navigating to different media types available on the multimedia console 100. In operation, applications and/or other media contained within the media drive 144 may be launched or played from the media drive 144 to provide additional functionalities to the multimedia console 100.

The multimedia console 100 may be operated as a standalone system by simply connecting the system to a television or other display. In this standalone mode, the multimedia console 100 allows one or more users to interact with the system, watch movies, or listen to music. However, with the integration of broadband connectivity made available through the network interface 124 or the wireless adapter 148, the multimedia console 100 may further be operated as a participant in a larger network community.

When the multimedia console 100 is powered ON, a set amount of hardware resources are reserved for system use by the multimedia console operating system. These resources may include a reservation of memory (e.g., 16 MB), CPU and GPU cycles (e.g., 5%), networking bandwidth (e.g., 8 kbs.), etc. Because these resources are reserved at system boot time, the reserved resources do not exist from the application's view.

In particular, the memory reservation preferably is large enough to contain the launch kernel, concurrent system applications and drivers. The CPU reservation is preferably constant such that if the reserved CPU usage is not used by the system applications, an idle thread will consume any unused cycles.

With regard to the GPU reservation, lightweight messages generated by the system applications (e.g., pop-ups) are displayed by using a GPU interrupt to schedule code to render popup into an overlay. The amount of memory required for an overlay depends on the overlay area size and the overlay preferably scales with screen resolution. Where a full user interface is used by the concurrent system application, it is preferable to use a resolution independent of application resolution. A scaler may be used to set this resolution such that the need to change frequency and cause a TV resynch is eliminated.

After the multimedia console 100 boots and system resources are reserved, concurrent system applications execute to provide system functionalities. The system functionalities are encapsulated in a set of system applications that execute within the reserved system resources described above. The operating system kernel identifies threads that are system application threads versus gaming application threads. The system applications are preferably scheduled to run on the CPU 101 at predetermined times and intervals in order to provide a consistent system resource view to the application. The scheduling is to minimize cache disruption for the gaming application running on the console.

When a concurrent system application requires audio, audio processing is scheduled asynchronously to the gaming application due to time sensitivity. A multimedia console application manager (described below) controls the gaming application audio level (e.g., mute, attenuate) when system applications are active.

Input devices (e.g., controllers 142(1) and 142(2)) are shared by gaming applications and system applications. The input devices are not reserved resources, but are to be switched between system applications and the gaming application such that each will have a focus of the device. The application manager preferably controls the switching of input stream, without knowledge the gaming application's knowledge and a driver maintains state information regarding focus switches. The cameras 26, 28 and capture device 20 may define additional input devices for the console 100.

FIG. 4 illustrates another example embodiment of a computing environment 220 that may be the computing environment 12 shown in FIGS. 1A-2 used to interpret one or more gestures in a target recognition, analysis, and tracking system. The computing system environment 220 is only one example of a suitable computing environment and is not intended to suggest any limitation as to the scope of use or functionality of the presently disclosed subject matter. Neither should the computing environment 220 be interpreted as having any dependency or requirement relating to any one or combination of components illustrated in the exemplary operating environment 220. In some embodiments the various depicted computing elements may include circuitry configured to instantiate specific aspects of the present disclosure. For example, the term circuitry used in the disclosure can include specialized hardware components configured to perform function(s) by firmware or switches. In other examples embodiments the term circuitry can include a general purpose processing unit, memory, etc., configured by software instructions that embody logic operable to perform function(s). In example embodiments where circuitry includes a combination of hardware and software, an implementer may write source code embodying logic and the source code can be compiled into machine readable code that can be processed by the general purpose processing unit. Since one skilled in the art can appreciate that the state of the art has evolved to a point where there is little difference between hardware, software, or a combination of hardware/software, the selection of hardware versus software to effectuate specific functions is a design choice left to an implementer. More specifically, one of skill in the art can appreciate that a software process can be transformed into an equivalent hardware structure, and a hardware structure can itself be transformed into an equivalent software process. Thus, the selection of a hardware implementation versus a software implementation is one of design choice and left to the implementer.

In FIG. 4, the computing environment 220 comprises a computer 241, which typically includes a variety of computer readable media. Computer readable media can be any available media that can be accessed by computer 241 and includes both volatile and nonvolatile media, removable and non-removable media. The system memory 222 includes computer storage media in the form of volatile and/or nonvolatile memory such as read only memory (ROM) 223 and random access memory (RAM) 260. A basic input/output system 224 (BIOS), containing the basic routines that help to transfer information between elements within computer 241, such as during start-up, is typically stored in ROM 223. RAM 260 typically contains data and/or program modules that are immediately accessible to and/or presently being operated on by processing unit 259. By way of example, and not limitation, FIG. 4 illustrates operating system 225, application programs 226, other program modules 227, and program data 228.

The computer 241 may also include other removable/non-removable, volatile/nonvolatile computer storage media. By way of example only, FIG. 4 illustrates a hard disk drive 238 that reads from or writes to non-removable, nonvolatile magnetic media, a magnetic disk drive 239 that reads from or writes to a removable, nonvolatile magnetic disk 254, and an optical disk drive 240 that reads from or writes to a removable, nonvolatile optical disk 253 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 238 is typically connected to the system bus 221 through an non-removable memory interface such as interface 234, and magnetic disk drive 239 and optical disk drive 240 are typically connected to the system bus 221 by a removable memory interface, such as interface 235.

The drives and their associated computer storage media discussed above and illustrated in FIG. 4, provide storage of computer readable instructions, data structures, program modules and other data for the computer 241. In FIG. 4, for example, hard disk drive 238 is illustrated as storing operating system 258, application programs 257, other program modules 256, and program data 255. Note that these components can either be the same as or different from operating system 225, application programs 226, other program modules 227, and program data 228. Operating system 258, application programs 257, other program modules 256, and program data 255 are given different numbers here to illustrate that, at a minimum, they are different copies. A user may enter commands and information into the computer 241 through input devices such as a keyboard 251 and pointing device 252, commonly referred to as a mouse, trackball or touch pad. Other input devices (not shown) may include a microphone, joystick, game pad, satellite dish, scanner, or the like. These and other input devices are often connected to the processing unit 259 through a user input interface 236 that is coupled to the system bus, but may be connected by other interface and bus structures, such as a parallel port, game port or a universal serial bus (USB). The cameras 26, 28 and capture device 20 may define additional input devices for the console 100. A monitor 242 or other type of display device is also connected to the system bus 221 via an interface, such as a video interface 232. In addition to the monitor, computers may also include other peripheral output devices such as speakers 244 and printer 243, which may be connected through a output peripheral interface 233.

The computer 241 may operate in a networked environment using logical connections to one or more remote computers, such as a remote computer 246. The remote computer 246 may be a personal computer, a server, a router, a network PC, a peer device or other common network node, and typically includes many or all of the elements described above relative to the computer 241, although only a memory storage device 247 has been illustrated in FIG. 4. The logical connections depicted in FIG. 2 include a local area network (LAN) 245 and a wide area network (WAN) 249, but may also include other networks. Such networking environments are commonplace in offices, enterprise-wide computer networks, intranets and the Internet.

When used in a LAN networking environment, the computer 241 is connected to the LAN 245 through a network interface or adapter 237. When used in a WAN networking environment, the computer 241 typically includes a modem 250 or other means for establishing communications over the WAN 249, such as the Internet. The modem 250, which may be internal or external, may be connected to the system bus 221 via the user input interface 236, or other appropriate mechanism. In a networked environment, program modules depicted relative to the computer 241, or portions thereof, may be stored in the remote memory storage device. By way of example, and not limitation, FIG. 4 illustrates remote application programs 248 as residing on memory device 247. It will be appreciated that the network connections shown are exemplary and other means of establishing a communications link between the computers may be used.

The computer readable storage medium may comprise computer readable instructions for modifying a visual representation. The instructions may comprise instructions for rendering the visual representation, receiving data of a scene, wherein the data includes data representative of a user's modification gesture in a physical space, and modifying the visual representation based on the user's modification gesture, wherein the modification gesture is a gesture that maps to a control for modifying a characteristic of the visual representation.

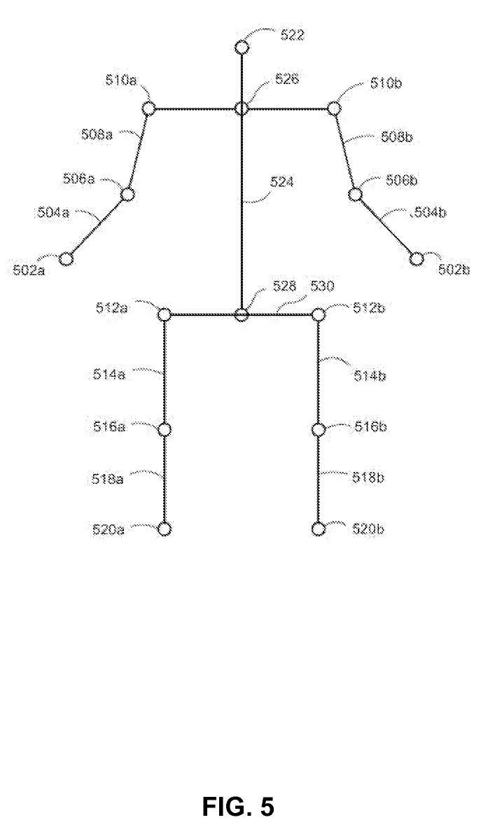

FIG. 5 depicts an example skeletal mapping of a user that may be generated from image data captured by the capture device 20. In this embodiment, a variety of joints and bones are identified: each hand 502, each forearm 504, each elbow 506, each bicep 508, each shoulder 510, each hip 512, each thigh 514, each knee 516, each foreleg 518, each foot 520, the head 522, the torso 524, the top 526 and bottom 528 of the spine, and the waist 530. Where more points are tracked, additional features may be identified, such as the bones and joints of the fingers or toes, or individual features of the face, such as the nose and eyes.

Through moving his body, a user may create gestures. A gesture comprises a motion or pose by a user that may be captured as image data and parsed for meaning A gesture may be dynamic, comprising a motion, such as mimicking throwing a ball. A gesture may be a static pose, such as holding one's crossed forearms 504 in front of his torso 524. A gesture may also incorporate props, such as by swinging a mock sword. A gesture may comprise more than one body part, such as clapping the hands 502 together, or a subtler motion, such as pursing one's lips.

A user's gestures may be used for input in a general computing context. For instance, various motions of the hands 502 or other body parts may correspond to common system wide tasks such as navigate up or down in a hierarchical list, open a file, close a file, and save a file. For instance, a user may hold his hand with the fingers pointing up and the palm facing the capture device 20. He may then close his fingers towards the palm to make a fist, and this could be a gesture that indicates that the focused window in a window-based user-interface computing environment should be closed. Gestures may also be used in a video-game-specific context, depending on the game. For instance, with a driving game, various motions of the hands 502 and feet 520 may correspond to steering a vehicle in a direction, shifting gears, accelerating, and braking. Thus, a gesture may indicate a wide variety of motions that map to a displayed user representation, and in a wide variety of applications, such as video games, text editors, word processing, data management, etc.

A user may generate a gesture that corresponds to walking or running, by walking or running in place himself. For example, the user may alternately lift and drop each leg 512-520 to mimic walking without moving. The system may parse this gesture by analyzing each hip 512 and each thigh 514. A step may be recognized when one hip-thigh angle (as measured relative to a vertical line, wherein a standing leg has a hip-thigh angle of 0°, and a forward horizontally extended leg has a hip-thigh angle of 90°) exceeds a certain threshold relative to the other thigh. A walk or run may be recognized after some number of consecutive steps by alternating legs. The time between the two most recent steps may be thought of as a period. After some number of periods where that threshold angle is not met, the system may determine that the walk or running gesture has ceased.

Given a “walk or run” gesture, an application may set values for parameters associated with this gesture. These parameters may include the above threshold angle, the number of steps required to initiate a walk or run gesture, a number of periods where no step occurs to end the gesture, and a threshold period that determines whether the gesture is a walk or a run. A fast period may correspond to a run, as the user will be moving his legs quickly, and a slower period may correspond to a walk.

A gesture may be associated with a set of default parameters at first that the application may override with its own parameters. In this scenario, an application is not forced to provide parameters, but may instead use a set of default parameters that allow the gesture to be recognized in the absence of application-defined parameters. Information related to the gesture may be stored for purposes of pre-canned animation.

There are a variety of outputs that may be associated with the gesture. There may be a baseline “yes or no” as to whether a gesture is occurring. There also may be a confidence level, which corresponds to the likelihood that the user's tracked movement corresponds to the gesture. This could be a linear scale that ranges over floating point numbers between 0 and 1, inclusive. Wherein an application receiving this gesture information cannot accept false-positives as input, it may use only those recognized gestures that have a high confidence level, such as at least.95. Where an application must recognize every instance of the gesture, even at the cost of false-positives, it may use gestures that have at least a much lower confidence level, such as those merely greater than.2. The gesture may have an output for the time between the two most recent steps, and where only a first step has been registered, this may be set to a reserved value, such as −1 (since the time between any two steps must be positive). The gesture may also have an output for the highest thigh angle reached during the most recent step.

Another exemplary gesture is a “heel lift jump.” In this, a user may create the gesture by raising his heels off the ground, but keeping his toes planted. Alternatively, the user may jump into the air where his feet 520 leave the ground entirely. The system may parse the skeleton for this gesture by analyzing the angle relation of the shoulders 510, hips 512 and knees 516 to see if they are in a position of alignment equal to standing up straight. Then these points and upper 526 and lower 528 spine points may be monitored for any upward acceleration. A sufficient combination of acceleration may trigger a jump gesture. A sufficient combination of acceleration with a particular gesture may satisfy the parameters of a transition point.

Given this “heel lift jump” gesture, an application may set values for parameters associated with this gesture. The parameters may include the above acceleration threshold, which determines how fast some combination of the user's shoulders 510, hips 512 and knees 516 must move upward to trigger the gesture, as well as a maximum angle of alignment between the shoulders 510, hips 512 and knees 516 at which a jump may still be triggered. The outputs may comprise a confidence level, as well as the user's body angle at the time of the jump.

Setting parameters for a gesture based on the particulars of the application that will receive the gesture is important in accurately identifying gestures. Properly identifying gestures and the intent of a user greatly helps in creating a positive user experience.

An application may set values for parameters associated with various transition points to identify the points at which to use pre-canned animations. Transition points may be defined by various parameters, such as the identification of a particular gesture, a velocity, an angle of a target or object, or any combination thereof. If a transition point is defined at least in part by the identification of a particular gesture, then properly identifying gestures assists to increase the confidence level that the parameters of a transition point have been met.

Another parameter to a gesture may be a distance moved. Where a user's gestures control the actions of an avatar in a virtual environment, that avatar may be arm's length from a ball. If the user wishes to interact with the ball and grab it, this may require the user to extend his arm 502-510 to full length while making the grab gesture. In this situation, a similar grab gesture where the user only partially extends his arm 502-510 may not achieve the result of interacting with the ball. Likewise, a parameter of a transition point could be the identification of the grab gesture, where if the user only partially extends his arm 502-510, thereby not achieving the result of interacting with the ball, the user's gesture also will not meet the parameters of the transition point.

A gesture or a portion thereof may have as a parameter a volume of space in which it must occur. This volume of space may typically be expressed in relation to the body where a gesture comprises body movement. For instance, a football throwing gesture for a right-handed user may be recognized only in the volume of space no lower than the right shoulder 510a, and on the same side of the head 522 as the throwing arm 502a-310a. It may not be necessary to define all bounds of a volume, such as with this throwing gesture, where an outer bound away from the body is left undefined, and the volume extends out indefinitely, or to the edge of scene that is being monitored.

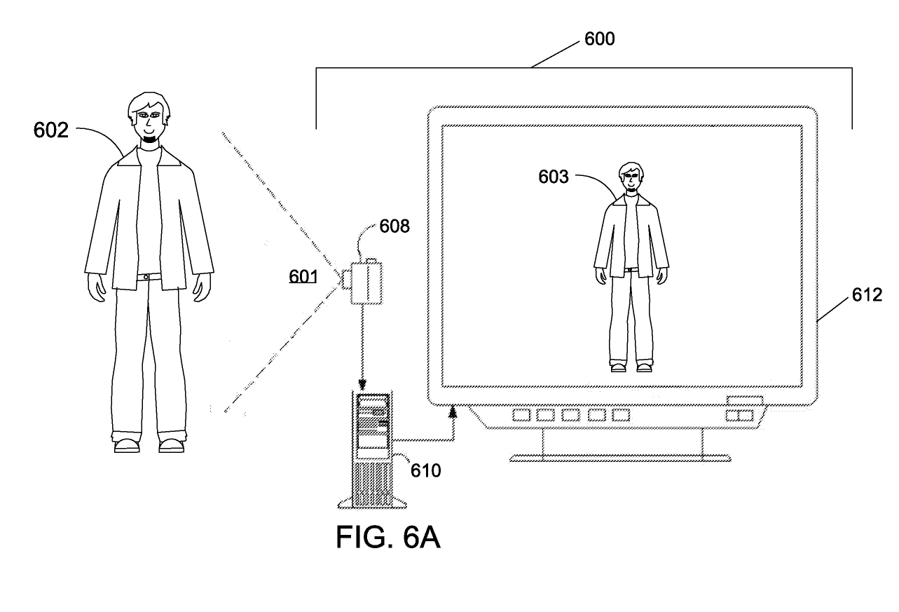

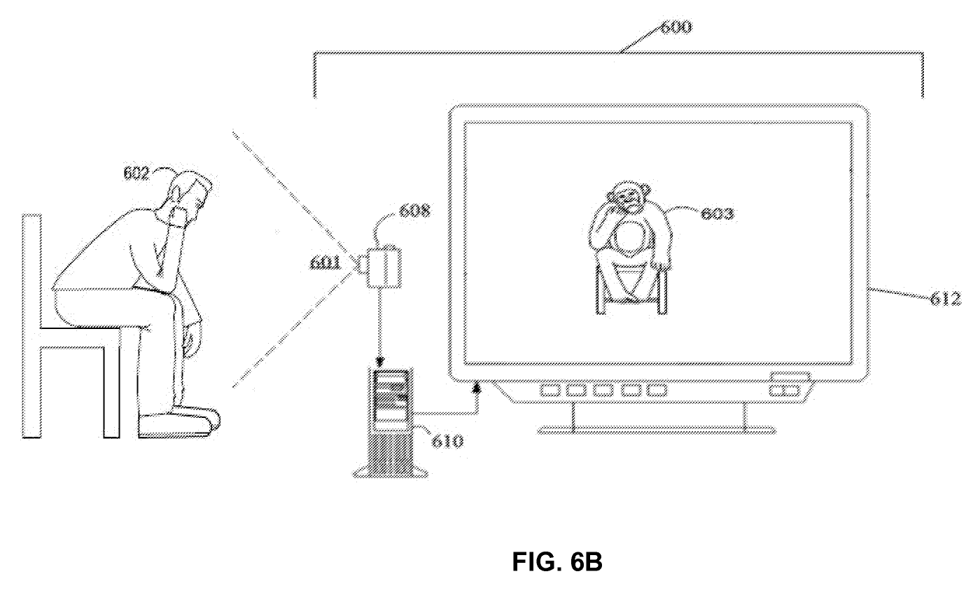

FIGS. 6A and 6B depict a system 600 that may comprise a capture device 608, a computing device 610, and a display device 612. For example, the capture device 608, computing device 610, and display device 612 may each comprise any suitable device that performs the desired functionality, such as the devices described with respect to FIGS. 1-5. It is contemplated that a single device may perform all of the functions in system 600, or any combination of suitable devices may perform the desired functions. For example, the computing device 610 may provide the functionality described with respect to the computing environment 12 shown in FIG. 2 or the computer in FIG. 3. As shown in FIG. 2, the computing environment 12 may include the display device and a processor. The computing device 610 may also comprise its own camera component or may be coupled to a device having a camera component, such as capture device 608.

In these examples, a depth camera 608 captures a scene in a physical space 601 in which a user 602 is present. The depth camera 608 processes the depth information and/or provides the depth information to a computer, such as computer 610. The depth information can be interpreted for display of a visual representation of the user 602. For example, the depth camera 608 or, as shown, a computing device 610 to which it is coupled, may output to a display 612. The rate that frames of image data are captured and displayed may determine the level of continuity of the displayed motion of the visual representation. Though additional frames of image data may be captured and displayed, the frames depicted in each of FIGS. 6A and 6B is selected for exemplary purposes. It is also noted that the visual representation may be of another target in the physical space 601, such as another user or a non-human object, or the visual representation may be a partial or entirely virtual object.

The techniques herein disclose the system's ability to auto-generate a visual representation of a target that has features resembling the detected features of the target. Alternately, the system may provide a subset of selectable features from which the user may choose. The system may select the features based on the detected features of the target and apply the selections to the visual representation of the target. Alternately, the system may make selections that narrow down the number of options from which the user chooses. The user may not be required to make as many decisions or have to select from as many options if the system can make decisions on behalf of the user. Thus, the disclosed techniques may remove a large amount of the effort from a user. For example, the system can make selections, on behalf of the user, and apply them to the user's visual representation.

As shown in FIG. 6A, the system renders a visual representation 603 that corresponds to the user 602 in the physical space 601. In this example, the system auto-generated the visual representation 603 by detecting features of the user 602, comparing the detected features to a library of feature options, selecting the feature options that resemble the detected features of the user 602, and automatically applying them to the user's visual representation 603. The auto-generation of the visual representation removes work from the user 602 and creates a magical experience for the user 602 as they are effortlessly transported into the game or application experience.

Also disclosed are techniques for displaying the visual representation in real time and updating the feature selections applied to the visual representation in real time. The system may track the user in the physical space over time and apply modifications or update the features applied to the visual representation, also in real time. For example, the system may track a user and identify that the user has removed a sweatshirt. The system may identify the user's body movements and recognize a change in the user's clothing type and color. The system may use any of the user's identified characteristics to assist in the feature selection process and/or updated the features selected from the features library and applied to the visual representation. Thus, again, the system may effortlessly transport the user into the application experience and update the visual representation to correspond, in real time, to the user's detected features as they may change.

In an example embodiment, to detect features of the user and use the detected features to select options for the visual representation's features, the system may generate a model of the user. To generate the model, a capture device can capture an image of the scene and scan targets or objects in the scene. According to one embodiment, image data may include a depth image or an image from a depth camera 608 and/or RGB camera, or an image on any other detector. The system 600 may capture depth information, image information, RGB data, etc, from the scene. To determine whether a target or object in the scene corresponds to a human target, each of the targets may be flood filled and compared to a pattern of a human body model. Each target or object that matches the human pattern may be scanned to generate a model such as a skeletal model, a flood model, a mesh human model, or the like associated therewith. The skeletal model may then be provided to the computing environment for tracking the skeletal model and rendering an avatar associated with the skeletal model.

Image data and/or depth information may be used in to identify target features. Such target features for a human target may include, for example, height and/or arm length and may be obtained based on, for example, a body scan, a skeletal model, the extent of a user 602 on a pixel area or any other suitable process or data. Using for example, the depth values in a plurality of observed pixels that are associated with a human target and the extent of one or more aspects of the human target such as the height, the width of the head, or the width of the shoulders, or the like, the size of the human target may be determined. The camera 608 may process the image data and use it to determine the shape, colors, and size of various parts of the user, including the user's hair, clothing, etc. The detected features may be compared to a catalog of feature options for application to a visual representation, such as the visual representation feature options in the features library 197.

In another example embodiment, to identify characteristics of the user and use the identified characteristics to select features for the visual representation, the system may use target digitization techniques, such as those described with respect to FIG. 2B. The techniques comprise identifying surfaces, textures, and object dimensions from unorganized point clouds derived from a capture device, such as a depth sensing device. Employing target digitization may comprise surface extraction, identifying points in a point cloud, labeling surface normals, computing object properties, tracking changes in object properties over time, and increasing confidence in the object boundaries and identity as additional frames are captured. For example, a point cloud of data points related to objects in a physical space may be received or observed. The point cloud may then be analyzed to determine whether the point cloud includes an object. A collection of point clouds may be identified as an object and fused together to represent a single object. A surface of the point clouds may be extracted from the object identified.

Any known technique or technique disclosed herein that provides the ability to scan a known/unknown object, scan a human, and scan background aspects in a scene (e.g., floors, walls) may be used to detect features of a target in the physical space. The scan data for each, which may include a combination of depth and RGB data, may be used to create a three-dimensional model of the object. The RGB data is applied to the corresponding area of the model. Temporal tracking, from frame to frame, can increase confidence and adapt the object data in real-time. Thus, the object properties and tracking of changes in the object properties over time may be used to reliably track objects that change in position and orientation from frame to frame in real time. The capture device captures data at interactive rates, increasing the fidelity of the data and allowing the disclosed techniques to process the raw depth data, digitize the objects in the scene, extract the surface and texture of the object, and perform any of these techniques in real-time such that the display can provide a real-time depiction of the scene.

Camera recognition technology can be used to determine which elements in the features library 197 most closely resemble characteristics of the user 602. The system may use facial recognition and/or body recognition techniques to detect features of the user 602. For example, the system may detect features of the user based on the generation of the models from the image data, point cloud data, depth data, or the like. A facial scan may take place and the system may process the data captured with respect to the user's facial features and RGB data. In an example embodiment, based on the location of five key data points (i.e., eyes, corner points of the mouth, and nose), the system suggests a facial recommendation for a player. The facial recommendation may include at least one selected facial feature, an entire set of facial features, or it may be a narrowed subset of options for facial features from the features library 197. The system may perform body recognition techniques, identifying various body parts/types from a body scan. For example, a body scan of the user may provide a suggestion for the user's height. For any of these scans, the user may be prompted to stand in the physical space in a position that provides for the best scan results.

Other features may be detected from the captured data. For example, the system may detect color data and clothing data by analyzing the user and/or the model of the user. The system may recommend clothing for the user based on the identity of these user characteristics. The clothing recommendations may be based on clothing in the user's closet or from clothing available for purchase in the virtual world marketplace. For example, a user may have a personal closet with a repository of items owned and associated with a particular visual representation. The personal closet may comprise an interface for allowing the user to view and modify clothing and other items that are applied to the user's visual representation. For example, accessories, shoes, etc, may be modified. A user's gender may be determined based on the captured data or as a result of accessing a profile associated with the user.

The system may detect at least one of the user's features and select a feature from the features library 197 that is representative of the detected feature. The system may automatically apply the selected feature to the user's visual representation 603. Thus, the user's visual representation 603 has the likeness of the user as selected by the system. For example, feature extraction techniques may map the user's facial features, and feature options selected from the features library may be used to create a cartoon representation of the user. The visual representation 603 is auto-generated with selected features from the features library that resemble the user's detected features, but in this example the visual representation is a cartoon version of the user 602. The visual representation has a cartoon version of the user's 602 hair, eyes, nose, clothes (e.g., jeans, jacket, shoes), body position and type, etc. The system may present the visual representation 603 to the user 602 that is created by applying the features and rendering the auto-generated visual representation 603. The user 602 may modify the auto-generated visual representation 603 or continue to make selections for application to the visual representation.

The visual representation of a user detected in the physical space 601 can also take alternate forms, such as an animation, a character, an avatar, or the like. The example visual representation shown in FIG. 6B is that of a monkey character 605. The user 602 may select from a variety of stock models that are provided by the system or application for the on-screen representation of the user. For example, in a baseball game application, the stock models available for visually representing the user 602 may include representation of a well-known baseball player to a piece of taffy or an elephant to a fanciful character or symbol, such as a cursor or hand symbol. In the example shown in FIG. 6B, the monkey character 605 may be a stock model representation provided by the system or application. The stock model may be specific to an application, such as packaged with a program, or the stock model may be available across-applications or available system-wide.

The visual representation may be a combination of the user's 602 features and an animation or stock model. For example, the monkey representation 605 may be initialized from a stock model of a monkey, but various features of the monkey may be modified by features that resemble the user as selected by the system 600 from a catalog of feature options, such as those in the features library 197. The system may initialize the visual representation with the stock model, but then proceed with detecting features of the user, comparing the detected features to a feature library 197, selecting features that resemble the user, and apply the selected features to the monkey character 605. Thus, the monkey 605 may have a monkey's body, but have the user's facial features, such as eyebrows, eyes, and nose. The user's facial expressions, body position, words spoken, or any other detectable characteristic may be applied to the virtual monkey 605, and modified if appropriate. For example, the user is frowning in the physical space. The system detects this facial expression, selects a frown from the features library that most closely resembles the user's frown, and applies the selected frown to the monkey such that the virtual monkey is also frowning. Further, the monkey is seated in a position similar to the user, except modified to correspond to a monkey's body type and size in that position. The system 600 may compare the detected target body type features to the features library 197 that stores a collection of possible visual representation features for body type. The system may select features from a subset of monkey features in the features library. For example, the application may provide monkey-specific feature options in the features library to correspond to a stock model monkey character option pre-packaged with the application. The system or user may select from the options for monkey-specific features that most closely resemble the user's detected features.

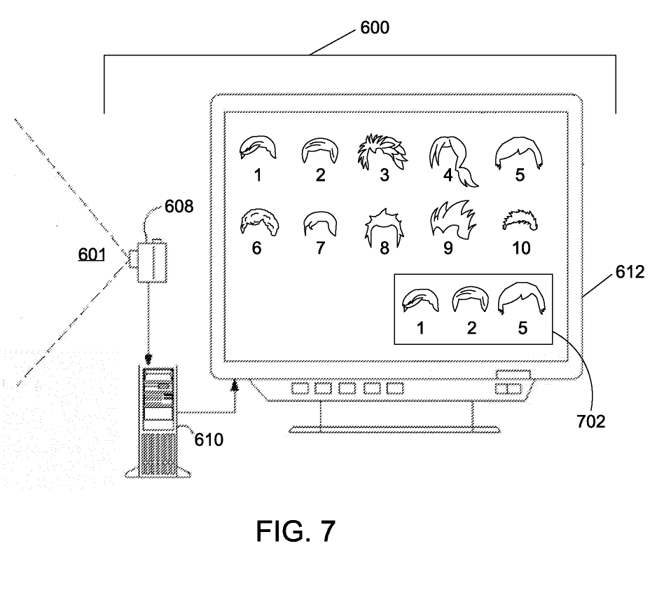

It may be desirable that the system provide a subset of features from the features library 197. For example, more than one option in the features library 197 may resemble the detected feature of the user. The system may provide a small subset of features from which the user choose. Instead of the user manually choosing from tens, hundreds, even thousands of feature options, the system may provide a narrowed subset of options. For example, FIG. 7 depicts the system 600 as shown in FIGS. 6A and 6B. On the display 612, the system displays an example set of feature options for a visual representation's hair, options 1-10. In FIG. 6A, the system automatically selected hair option #5 for application to the user's visual representation. In the example shown in FIG. 7, however, the system has selected a subset of hair options 702 that most closely resemble the user's detected hair features. Thus, the user can select from the subset of options 702 for application to the user's visual representation.

In this example, the subset of feature options 702 for hair may include selections that most closely resemble the user's features detected from a body and facial scan, including the user's hair shape, color, and type. Instead of an overwhelming number of hair options from which to choose, the system may provide a smaller list of options for the hair options that most closely resemble the user's hair shape, color, and type. The system may auto-generate a visual representation, but may also be designed to provide more than one option from which the user may choose so that the user may make the final detailed selections between feature options that most please the user. The subset of options reduces the user's need to evaluate all of the options.

The user or application may have settings for modifying certain features that correspond to the user's characteristics, before applying them to the visual representation. For example, the system may detect a certain weight range for a user based on the captured data (e.g., body type/size). However, the user may set or the application itself may have default values set such that a user is displayed within a certain weight range rather than the actual user's weight range. Thus, a more flattering visual representation may be displayed for the user, rather than one that may be overweight, for example. In another example, the user's facial features may be detected and the features applied to the user's visual representation may correspond to the detected features such that the facial features of the visual representation resemble the user's features in size, proportion, spatial arrangement on the head, or the like. The user can modify the realistic effects of the facial recognition techniques by changing the features. For example, the user may modify the features by changing a sliding sale. The user may make changes to a sliding scale to modify the weight to apply to the visual representation, or to change the size of the nose to be applied to the visual representation. Thus, some features selected by the system may be applied, others may be modified and then applied.

Certain target characteristics detected by the system may be modified for display purposes. For example, target characteristics may be modified to correspond to the form of the visual representation, the application, the status of the application, etc. For example, certain characteristics may not map directly to the visual representation of the user where the visual representation is a fanciful character. Any visual representation of the user, such as the avatar 603 or character representation of the user, such as the monkey 605, may be given body proportions, for example, that are similar to the user 602, but modified for the particular character. For example, the monkey representation 605 may be given a height that is similar to the user 602, but the monkey's arms may be proportionately longer than the user's arms. The movement of the monkey's 605 arms may correspond to the movement of the user's arms, as identified by the system, but the system may modify the animation of the monkey's arms to reflect the way a monkey's arms would move.

The system can use captured data, such as scanned data, image data or depth information, to identify other target characteristics. The target characteristics may comprise any other features of the target, such as: eye size, type, and color; hair length, type, and color; skin color; clothing and clothing colors. For example, colors may be identified based on a corresponding RGB image. The system can also map these detectable features to the visual representation. For example, the system may detect that the user is wearing glasses and has a red shirt on and apply glasses and system may apply glasses and a red shirt to the virtual monkey 605 which, in this example, is the visual representation of the user.

The depth information and target characteristics may also be combined with additional information including, for example, information that may be associated with the particular user 602 such as a specific gesture, voice recognition information, or the like. The model may then be provided to the computing device 610 such that the computing device 610 may track the model, render a visual representation associated with the model, and/or determine which controls to perform in an application executing on the computing device 610 based on, for example, the model.

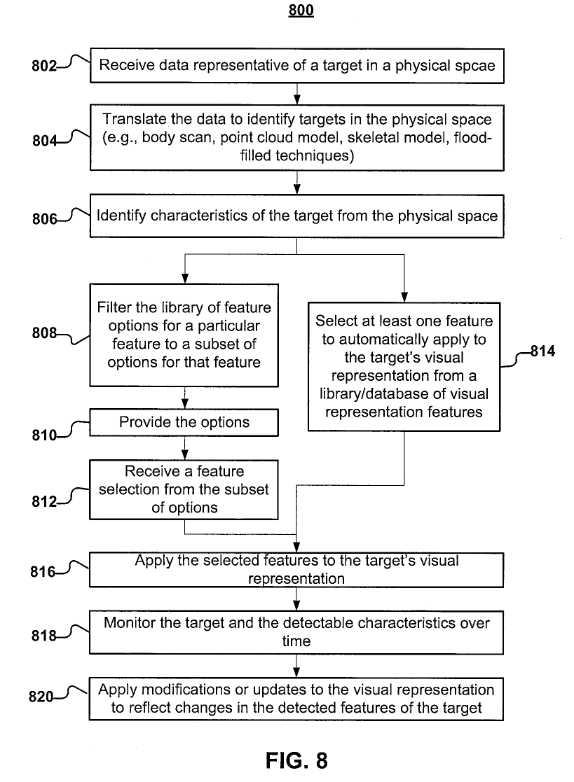

FIG. 8 shows an example method of providing feature selections to a user. The provision of feature selections may be provided by a display of the visual representation with the features applied or a subset of the library of features with a narrowed down subset of options from which the user may choose. For example, at 802, the system receives data from a physical space that includes a target, such as a user or a non-human object.

As described above, a capture device can capture data of a scene, such as the depth image of the scene and scan targets in the scene. The capture device may determine whether one or more targets in the scene corresponds to a human target such as a user. For example, to determine whether a target or object in the scene corresponds to a human target, each of the targets may be flood filled and compared to a pattern of a human body model. Each target or object that matches the human body model may then be scanned to generate a skeletal model associated therewith. For example, a target identified as a human may be scanned to generate a skeletal model associated therewith. The skeletal model may then be provided to the computing environment for tracking the skeletal model and rendering a visual representation associated with the skeletal model. At 804, the system may translate the captured data to identify the features of the targets in the physical space by using any suitable technique, such as a body scan, point cloud models, skeletal models, flood-filled techniques, or the like.

At 806, the system may detect characteristics of the target and compare them to feature options, such as feature options in a features library. The feature options may be a collection of options for various features for the target. For example, feature options for a user may include eyebrow options, hair options, nose options, etc. Feature options for furniture in a room may include size options, shape options, hardware options, etc.

In an example embodiment, the system may detect several features available for application to the visual representation that resemble the user's detected features. Thus, at 806, the system may detect a feature of the user compare the detected feature to the features library 197 for application to the user's visual representation, and, at 810, the system may select a subset of the feature options based on the detected feature. The system may select the subset as those features by comparing the similarities of the features in the features library 197 to the detected characteristics of the user. Sometimes, a feature will be very similar, but the system may still provide the user a subset of options to choose from at 810. In this manner, the user can select a feature from the subset that is at least similar to the user's corresponding characteristic, but can select a more flattering feature from that subset, for example. The system may receive the user's selection from the subset of options at 812. Thus, the user does not have to filter an entire library of options for the particular feature for features that are similar to the user. The system can filter the library of options and provide the user a subset of features from which to choose.

The system may auto-generate a visual representation of the user at 814. Thus, upon comparison of the target's detected features to the options in the features library, the system may auto-generate a visual representation of the target by automatically selecting the features to apply to the visual representation. The target is effortlessly transported into the system or software experience when the system automatically renders a visual representation that corresponds to the user, having automatically selected features from the features library that resemble the detected features of the target.

The visual representation may have a combination of automatically selected features and features selected by the user based on the subset of options provided by the system. Thus, the visual representation may be partially generated and partially customized by the user.

The selections made by the system and/or the user may be applied to the target's visual representation at 816. The system may render the visual representation to the user. At 818, the system may continue to monitor the target in the physical space, tracking the detectable features of the target over time. Modifications to the target's visual representation may be made in real time to reflect any changes to the target's detected features. For example, if the target is a user and the user takes off a sweatshirt in the physical space, the system may detect a new shirt style and/or color, and automatically select an option from the features library that closely resembles the user's shirt.

The selected option may be applied to the user's visual representation in real time. Thus, the processing in the preceding steps may be performed in real time such that the display corresponds to the physical space in real time. In this manner, an object, a user, or motion in the physical space may be translated for display in real time such that the user may interact with an executing application in real time.

The user's detected features, the selected features by the system, and any selected features by the user may become part of a profile, at 822. The profile may be specific to a particular physical space or a user, for example. Avatar data, including features of the user, may become part of the user's profile. A profile may be accessed upon entry of a user into a capture scene. If a profile matches a user based on a password, selection by the user, body size, voice recognition or the like, then the profile may be used in the determination of the user's visual representation. History data for a user may be monitored, storing information to the user's profile. For example, the system may detect features specific to the user, such as the user's facial features, body types, etc. The system may select the features that resemble the detected features for application to the target's visual representation and for storage in the target profile

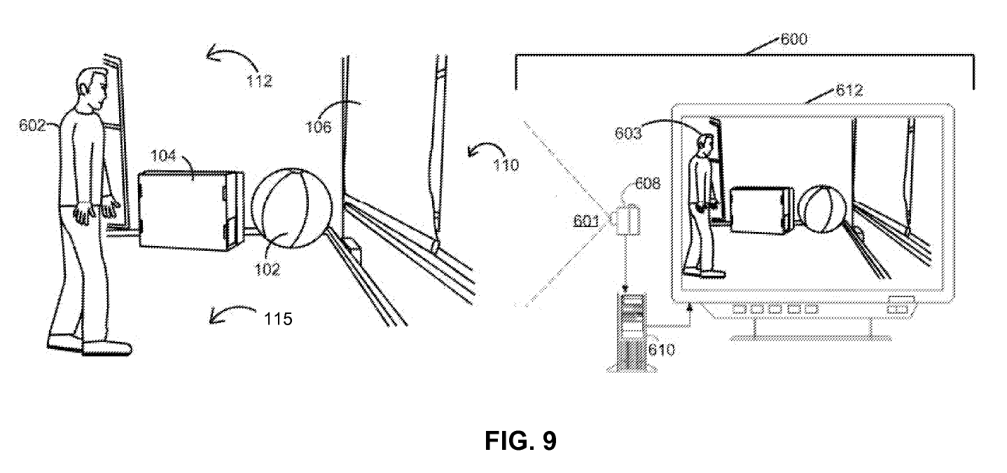

FIG. 9 depicts an example of the system 600 from FIG. 6 that can process information received for targets in a physical space 601 and identify the targets using target digitization techniques. The captured targets can be mapped to visual representations of those targets in the virtual environment. In this example, the physical scene includes the ball 102, box 104, window shade 106, wall rail 108, wall #1 110, wall #2 112, and the floor 115 that are shown in the physical space depicted in FIG. 1A. Further shown in the scene is a user 602. In an example embodiment, the system 10 may recognize, analyze, and/or track any of these objects, 102, 104, 106, 108, 110, 112, and 115, as well as other targets, such as a human target such as the user 602. The system 10 may gather information related to each of the objects 102, 104, 106, 108, 110, 112, and 114, and/or the user's 602 gestures in the physical space. A user in the physical space, such as user 602 may also enter the physical space.

The target may be any object or user in the physical space 601. For example, the capture device 608 may scan a human 602 or a non-human object, such as a ball 607, a cardboard box 609, or a dog 605, in the physical space 601. In this example, the system 600 may capture a target by scanning the physical space 601 using a capture device 608. For example, a depth camera 608 may receive raw depth data. The system 600 may process the raw depth data, interpret the depth data as point cloud data, convert the point cloud data to surface normals. For example, a depth buffer may be captured and converted into a ordered point cloud.

A depth buffer may be a buffer that records the depth of each pixel that is rendered. The depth buffer may keep record of additional pixels as they are rendered and determine the relationships between the depths of different pixels that are rendered. For example, the depth buffer may perform hidden surface removal and compare each pixel that is to be rendered with the pixel already in the frame buffer at that position. Also called a z-buffer, the depth buffer may compose a frame buffer that stores a measure of the distance from the capture device to each visible point in a captured image.

Based on the point clouds and surface normals identified, the system 600 may label objects parsed in the scene, clean up noise, and compute an orientation for each of the objects. A bounding box may be formed around an object. The object may then be tracked from frame-to-frame for texture extraction.

According to one embodiment, image data may include a depth image or an image from a depth camera and/or RGB camera, or an image on any other detector. For example, camera 608 may process the image data and use it to determine the shape, colors, and size of a target. In this example, the targets 602, 102, 104, 106, 108, 110, 112, and 114, in the physical space 601 are captured by a depth camera 608 that processes the depth information and/or provides the depth information to a computer, such as a computer 610.

The depth information may be interpreted for display of a visual representation on display 612. The system may use the information to select options from a features library 197 to generate virtual objects to correspond to the targets in the physical space. Each target or object that matches the human pattern may be scanned to generate a model such as a skeletal model, a mesh human model, or the like associated therewith. Each target or object that matches a library of known objects may be scanned to generate a model that is available for that particular object. Unknown objects may also be scanned to generate a model that corresponds to the point cloud data, RGB data, surface normals, orientation, bounding box, and any other processing of the raw depth data that corresponds to the unknown object.

The rate that frames of image data are captured and displayed determines the level of continuity of the display of the visual representation, as the targets may move in the physical space. Further, over time, the number of frame-to-frame images may increase the confidence of the way in which the point cloud data is parsed into separately labeled objects. Movement of an object may give further depth information regarding the surface normals and orientation. The system 600 may be able to further distinguish noise from desired point data. The system 600 may also identify a gesture from the user's 602 motion by evaluating the user's 602 position in a single frame of capture data or over a series of frames.

The system 600 may track any of the targets 602, 102, 104, 106, 108, 110, 112, and 114 in the physical space 601 such that the visual representation on display 612 maps to the targets 602, 102, 104, 106, 108, 110, 112, and 114 and motions of any of those targets captured in the physical space 601. The object in the physical space may have characteristics that the capture device can capture and scan to compare to feature options in a features library, such as features library 197 shown in FIG. 2. The system may select features from the features library that most closely resemble the detected features of the target.

Disclosed herein are techniques for computer vision that pertain to the implementation of target digitization. These techniques may be employed to enable the system to compare features captured at high fidelity to best select features from the features library that resemble the target features. Computer vision is the concept of understanding the content of scene by creating models of objects in the physical space from captured data, such as raw depth or image data. For example, the techniques may include surface extraction, the interpretation of points in a point cloud based on proximity to recover surface normal, computation of object properties, tracking the object properties over time, increasing confidence in object identification and shape over time, and scanning a human or known/unknown objects.

The capture device may scan a physical space and receive range data regarding various objects in the physical space 601. The scan may include a scan of the surface of an object or a scan of the entire solid. By taking the raw depth data in the form of a two-dimensional depth buffer, any suitable computing device may interpret a large number of points on the surface of an object and output a point cloud. A point cloud may be a set of data points defined in a three-dimensional coordinate system, such as data points defined by x, y, and z coordinates. The point cloud data may represent the visible surfaces of objects in the physical space that have been scanned. Thus, an object may be digitized by representing objects in the scene as a discrete set of points. The point cloud data may be saved in a data file as two-dimensional data set.

The range data may be captured in real time using a capture device such as a depth camera or a depth sensing device. For example, frames of data may be captured at a frequency of at least 20 hertz using a depth sensing camera in the form of a depth buffer. The data may be interpreted into a structured cloud of sample points, where each point may comprise characteristics of the associated target, such as location, orientation, surface normal, color or texture properties. The point cloud data can be stored in a two-dimensional data set. As the optical properties of the capture device are known, the range data can be projected into a full three-dimensional point cloud, which can thereby be stored in a regularized data structure. The three-dimensional point cloud may indicate the topology of the object's surface. For example, the relations between adjacent parts of the surface may be determined from the neighboring points in the cloud. The point cloud data can be converted into a surface, and the surface of the object represented by the point cloud data may be extracted by evaluating the surface normals over the surface of the point cloud data. The regularized data structure may be analogous to a two-dimensional depth buffer.

A point cloud may comprise a number of data points related to various objects in a physical space. The point cloud data may be received or observed by a capture device, such as that described herein. The point cloud may then be analyzed to determine whether the point cloud includes an object or a set of objects. If the data includes an object, a model of the object may be generated. An increase in confidence in the object identification may occur as frames are captured. Feedback of the model associated with a particular object may be generated and provided real time to the user. Further, the model of the object may be tracked in response to any movement of the object in the physical space such that the model may be adjusted to mimic the movement of the object.

All of this can be done at a rate for processing and a real-time display of the results. A real-time display refers to the display of a visual representation of a gesture or display of visual assistance, wherein the display is simultaneously or almost simultaneously displayed with the performance of the gesture in the physical space. For example, an update rate of the display at which the system may provide a display that echoes a user and the user's environment may be at a rate of 20 Hz or higher, wherein insignificant processing delays result in minimal delay of the display or are not visible at all to the user. Thus, real-time includes any insignificant delays pertaining to the timeliness of data which has been delayed by the time required for automatic data processing.

The capture device captures data at interactive rates, increasing the fidelity of the data and allowing the disclosed techniques to process the raw depth data, digitize the objects in the scene, extract the surface and texture of the object, and perform any of these techniques in real-time such that the display can provide a real-time depiction of the scene. In order to cluster groups of points in the cloud into discrete objects in the scene for any given frame, the depth buffer may be walked in scan lines left to right and then top to bottom. Each corresponding point or cluster of points in the cloud may be processed at the time of scan.

The camera may capture depth and color data and assign color to the point clouds that correspond to the color data. Thus, the camera may interpret the depth data to represent the physical space in three-dimensional as the capture device views it from the camera's point of view. The three-dimensional point cloud data can be fused and joined such that the points become a point cloud, and a subset of points in the cloud may be labeled as a particular object. From this labeled point cloud, three-dimensional data can be recovered for each labeled object and a corresponding mesh model created. Because the color information is correlated to the depth information, texture and surface for an object can also be extracted. Such target digitization may be useful for gaming applications or non-gaming applications, such as operating systems or software applications. Providing feedback on a display device that is in real-time with respect to the capture and processing of the depth data provides for a rewarding interactive experience, such as playing a game.

In the example depicted in FIG. 8, the walls, ceilings, and floor are in the physical space. From the analysis of point cloud data resulting from processing the raw depth data received by a capture device, such as the point cloud data represented in FIG. 7B, the system may label the walls and floors. Then, additional information about the physical scene may be extracted, such as the shape of the room. Using basic information about the physical space, the system can select from a features library to generate a virtual space that corresponds to the physical space. For example, the features library may include cartoon drawings of various features, and so the auto-generated virtual space may be a cartoon version of the physical space. However, the cartoon version

The information in the depth buffer may be used to separate surfaces from the objects identified from the raw depth data. The first pass walk by the depth buffer may be used to compute a normal map for the depth buffer based on surface normal's derived from the point cloud. Thus, rather than individual points in space, the system may derive the direction to which the surface points. The system may recover surface normals from the depth buffer and store the surface normals with the points in the cloud to which the surface normals are associated. The surface normals may be used to identify shapes and contours of an object. For example, a sphere may have a gradual constant change in the direction of normals over the entire surface. The surface normals for various objects may differ in various object filters for comparing to the surface normals detected in a scene.

Although a computation of surface normals and normal map computations are common techniques disclosed herein for identifying a surface from the point cloud data, any suitable surface separating or extraction technique may be used, such as Hough Transforms, normal mapping, Fourier transforms, Curvelet transforms, etc. For example, the computation for separating and/or extracting surfaces from a point cloud could be accomplished using a Hough Transform for planar surfaces. A normal map would not be necessary in such instance, rather a Hough Transform of the point cloud could be produced. Thus, when points of the cloud are fused into objects and labeled, an evaluation of the Hough space for each point may indicate if a point lies on a plane with neighboring points, enabling the system to separately label specific planar surfaces constituent to a particular object. Any suitable separation/extraction technique may be used, and may be tuned to the overall labeling performance and characteristics dependent upon the scenario. While using various surface separation/extraction techniques may change the labeling heuristics, any suitable technique may be used for such identification and labeling and still enable the system to process the depth data in real time for generating and refreshing the display in real time to the user.

Noise may result from the type of depth sensor used. The first walk phase may include a noise suppression pass on the raw data. For example, a smoothing pass may be performed to remove noise from the normal map.

The points in a cloud may be labeled in a two-dimensional scan pass over the data set, where options that are close together and have similar surfaces identified may be labeled as belonging to the same object. For example, if the surface separating technique involves the generation of a normal map, data sets that are closet together and have similar surface normals may be labeled as belonging to the same object. The labeling provides a distinction between planar and gently curving surfaces while spatially joined or disjoint surfaces like floors and walls may be labeled separately. The points in connectivity with neighboring points may be labeled based on the distance between those points and the corresponding surface normals which point in a similar direction. Tuning the distance threshold and normal similarity threshold may result in a different size and curvature of the objects and surfaces being discretely labeled. The threshold and expected results for known objects may be stored in the object filters.

As shown in FIG. 7C, the point clouds for the ball 102 and box 104 are shown. The evaluation of the point cloud data in proximity and the surface normals identified from the collection of point clouds may distinguish the ball from the box. Thus, each object, 102 and 104, can be labeled. The labeling may simply be a unique identification. The combination of position of points in the cloud and surface normals is useful to differentiate between objects on a surface or objects that make up the object. For example, if a cup was sitting on top of box 104, the cup may be labeled with the same unique ID given to the box, as it may not yet be determined from the point cloud data that the objects are disjointed. However, by then accounting for surface normals, the system can determine that there is a ninety degree difference between the surface normals and determine that the objects should be labeled separately based on the proximity of points and point clouds. Thus, groups of data points in the point cloud that are consistent with structural surface elements may be associated and labeled.

The system can re-project the determined surface orientations of various point clouds and realign the texture as if it were on a planar surface. The technique enables the system to retexture the object more accurately. For example, if a user holds up a magazine with printed text, there is no limit to the orientation by which the user can hold up the magazine to the capture device. The capture device can re-project the captured texture of the magazine surface and re-project that texture, including the color information, text, and any texture.

An object that is labeled and has a set of parameters computed for which it encompasses, the system may perform or continue to perform analysis for purposes of increased fidelity, organization, and structure to the virtual scene. For example, a best fit bounding box may be a more accurate way to distinguish a particular object. The best fit bounding box may give orientation of the object in a particular frame. For example, the box with a coffee cup on top may initially be given a bounding box that includes both the point cloud of the box and the point cloud representing the coffee cup. In each frame, the system can evaluate that objects that are spatially in the same location as in the last frame and determine if the orientation is similar. The coffee cup may move from frame to frame and the system may identify that the cup is separate from the box and therefore generate a new bounding box for the cup and redefine the bounding box for the cardboard box.

Sometimes noise is introduced into the system due to insignificant particles or objects in the room, or based on the type of sensor used. For example, a set of points in a cloud may represent that of a fly, or the type of sensor used may result in extraneous points that are superfluous. To reduce noise, a cleaning phase may be performed to clean the sensor data or remove very small objects and objects that only have a small number of constituent point samples. For example, a dust particle or a fly in a scene may be captured, but the small number of constituent point samples representing the fly may not be significant enough to trigger the identity of surface normals associated with that point cloud. Thus, the small number of constituent point samples representing the fly may be extracted from the analysis. An initial pass of the point cloud data may use points together in objects that are spatially related to give a large array of objects. For example, a large collection of points may be a couch and labeled with a particular ID; another object may be the floor. A certain threshold may be set to identify the set of points that should be removed from the analysis. For example, if only 20 points are identified for an object and the spatial arrangement of the 20 points is in a relatively small area compared to the physical space or other objects in the scene, then the system may eliminate those 20 points.

An axis aligned bounding box may be used as a quick measure of total volume/space taken up by the object. Axis aligned refers to the special axis such as X, Y or Z and not the axis of the object in space. For example, the system may compute whether the surface is complex or simple (e.g. sphere or magazine has a simple surface; a doll or plant has a complex surface). Rotation of the object may be useful for the system to analyze and determine more refined characteristics of the object. The capture device may perform a solid scan of an object for volume estimation. The capture device may also provide references between point clouds and objects in the scene, such that a particular location for an object in reference to the physical space can be identified.

The computation of object properties and the tracking of these changes over time established a reliable technique for tracking objects that may change in position and orientation from frame to frame in real time. The use of temporal information to capture the changes may give further confidence to the parsing, identification, and labeling of objects in the scene as more frames are captured. Due to the size of a typical data set, such as 640×480 points, even complex processing can be achieved using the disclosed techniques. Data can be captured in frame sequences at a frequency of at least 20 Hertz.

Object parameters may be compared with those of a previous frame, and objects may be re-labeled to allow moving objects to be tracked in real-time while also maintaining continuous labeling from static objects. A confidence may be computed for each object, and the confidence factor may increase over time. Thus, static objects may move in and out of view due to occlusion while confidence in the object may remain high. The temporal analysis may comprise an evaluation of the last frame and the present frame. If the object is the same in each frame, then the object may be relabeled with the label it had in the previous frame to give coherence to labels and objects from frame to frame. Object and surface orientation and location may be used to estimate orientation of the depth camera as well as gather statistical data relating to the camera surroundings. For example, locations of major planar surfaces in many cases will equate to walls and floors.

It should be understood that the configurations and/or approaches described herein are exemplary in nature, and that these specific embodiments or examples are not to be considered limiting. The specific routines or methods described herein may represent one or more of any number of processing strategies. As such, various acts illustrated may be performed in the sequence illustrated, in other sequences, in parallel, or the like. Likewise, the order of the above-described processes may be changed.

Furthermore, while the present disclosure has been described in connection with the particular aspects, as illustrated in the various figures, it is understood that other similar aspects may be used or modifications and additions may be made to the described aspects for performing the same function of the present disclosure without deviating therefrom. The subject matter of the present disclosure includes all novel and non-obvious combinations and sub-combinations of the various processes, systems and configurations, and other features, functions, acts, and/or properties disclosed herein, as well as any and all equivalents thereof. Thus, the methods and apparatus of the disclosed embodiments, or certain aspects or portions thereof, may take the form of program code (i.e., instructions) embodied in tangible media, such as floppy diskettes, CD-ROMs, hard drives, or any other machine-readable storage medium. When the program code is loaded into and executed by a machine, such as a computer, the machine becomes an apparatus configured for practicing the disclosed embodiments.

In addition to the specific implementations explicitly set forth herein, other aspects and implementations will be apparent to those skilled in the art from consideration of the specification disclosed herein. Therefore, the present disclosure should not be limited to any single aspect, but rather construed in breadth and scope in accordance with the appended claims. For example, the various procedures described herein may be implemented with hardware or software, or a combination of both.

What is claimed:

1. A method for generating a visual representation of a target, the method comprising:
receiving data of a scene, wherein the data includes data representative of the target in a physical space;
detecting at least one target feature from the data;
comparing the at least one detected target feature to visual representation feature options, wherein the visual representation feature options comprise selectable options configured for application to the visual representation of the target;
selecting a visual representation feature from the visual representation feature options;
applying the visual representation feature to the visual representation of the target; and
rendering the visual representation.

2. The method of claim 1, wherein the visual representation is auto-generated from the comparison of the at least one detected target feature to the visual representation feature options such that the selection of the visual representation feature is performed without manual selection by a user.

3. The method of claim 1, wherein selecting the visual representation feature comprises selecting the visual representation feature that is similar to the at least one detected target feature.

4. The method of claim 1, wherein the visual representation feature is at least one of a facial feature, a body part, a color, a size, a height, a width, a shape, an accessory, or a clothing item.

5. The method of claim 1, further comprising:
generating a subset of visual representation feature options, from the visual representation feature options, for the visual representation feature; and
providing the generated subset of feature options for user selection of the visual representation feature to apply to the visual representation.

6. The method of claim 5, wherein the generated subset of visual representation feature options comprises a plurality of the visual representation feature options that are similar to the at least one detected target feature.

7. The method of claim 5, further comprising receiving the user selection of the visual representation feature from the generated subset of feature options, wherein selecting the visual representation feature from the visual representation feature options comprises selecting the visual representation feature that corresponds to the user selection.

8. The method of claim 1, wherein the visual representation, having the visual representation feature, is rendered in real time.

9. The method of claim 1, further comprising:
monitoring the target and detecting a change in the at least one detected target feature;
updating the visual representation of the target by updating the visual representation feature applied to the visual representation, in real time, based on the change in the at least one detected target feature.

10. The method of claim 1, further comprising, where the target is a human target, detecting a position of at least one of a user's eyes, mouth, nose, or eyebrows, and using the position to align a corresponding visual representation feature to the visual representation.

11. The method of claim 1, further comprising modifying the selected visual representation feature based on a setting that provides a desired modification.

12. The method of claim 11, wherein the modification is based on a sliding scale that can provide various levels of modification for the visual representation feature.

13. A device, the device comprising:
a capture device, the capture device for receiving data of the scene, wherein the data includes data representative of a target in the physical space; and
a processor, the processor for executing computer executable instructions, the computer executable instructions comprising instructions for:
detecting at least one target feature from the data;
comparing the at least one detected target feature to visual representation feature options, wherein the visual representation feature options comprise selectable options configured for application to a visual representation;
selecting a visual representation feature from the visual representation feature options; and
applying the visual representation feature to the visual representation of the target.

14. The device of claim 13, further comprising a display device for rendering the visual representation in real time, wherein the processor auto-generates the visual representation from the comparison of the at least one detected target feature to the visual representation feature options such that the selection of the visual representation feature is performed without manual selection by a user.

15. The device of claim 13, wherein selecting the visual representation feature comprises selecting the visual representation feature that is similar to the at least one detected target feature.

16. The device of claim 13, the computer executable instructions further comprising instructions for:
generating a subset of visual representation feature options, from the visual representation feature options, for the visual representation feature; and
providing the generated subset of feature options on a display device for user selection of the visual representation feature to apply to the visual representation.

17. The device of claim 16, wherein the generated subset of visual representation feature options comprises a plurality of the visual representation feature options that are similar to the at least one detected target feature.

18. The device of claim 16, the computer executable instructions further comprising instructions for receiving the user selection of the visual representation feature from the generated subset of feature options, wherein selecting the visual representation feature from the visual representation feature options comprises selecting the visual representation feature that corresponds to the user selection.

19. The device of claim 13, the computer executable instructions further comprising instructions for:
monitoring the target and detecting a change in the at least one detected target feature;
updating the visual representation of the target by updating the visual representation feature applied to the visual representation, in real time, based on the change in the at least one detected target feature.

20. The device of claim 13, the computer executable instructions further comprising instructions for modifying the selected visual representation feature based on a setting that provides a desired modification.
